(19) United States
(12) Patent Application Publication
(10) Pub. No.: US 2011/0109723 A1
(43) Pub. Date: May 12, 2011

(54) MOTION PICTURES

(76) Inventor: James Amachi Ashbey, London (GB)

(21) Appl. No.: 12/990,376

(22) PCT Filed: May 1, 2009
(86) PCT No.: PCT/GB09/50455

§ 371 Date: Jan. 14, 2011

(30) Foreign Application Priority Data
May 1, 2008 (GB) 0807953.5
Sep. 10, 2008 (GB) 0816498.0

(51) Int. Cl. H04N 13/00

(52) U.S. Cl. 348/44; 348/E13.002

(57) ABSTRACT

3D-enhanced 2D motion picture sequences comprise a single channel of sequential images. Each image in the channel comprises primary image content representing a scene consisting of a plurality of elements. At least some images in the channel further include temporal shadow image content, comprising a degraded and/or partially transparent image of at least one element of said primary image content corresponding to a view of said at least one element as seen in the primary image content of at least one other image from said channel. The temporal shadow content of the images varies within a series of successive images in a cyclical manner. The enhanced motion picture sequences provide a sense of 3D depth when viewed on conventional 2D displays without artificial viewing aids. Similar techniques can also be applied to enhance the 3D perception of stereoscopic motion picture sequences.

The present invention relates to motion picture sequences and to methods and apparatus for generating motion picture sequences. More particularly, the invention relates to motion picture sequences, and associated methods and apparatus for producing such motion picture sequences, in which an original 2D motion picture sequence is modified to include additional visual information, derived from the original sequence, that provides a sense of 3D depth.

According to one aspect of the invention, the modified sequence is a single image stream (or channel) comprising a single series of frames that is viewed by both the left and right eyes of a viewer. It is not a series of stereoscopic pairs (left and right image streams or channels) that are viewed separately by the left and right eyes respectively, as with conventional stereoscopic motion picture sequences.

According to a second aspect of the invention, however, similar methods are applied to provide an enhanced stereoscopic motion picture sequence that comprises separate left and right eye image streams (channels). Each of the left and right eye image streams of the enhanced sequence is, in effect, a modified 2D motion picture sequence. In one aspect, the same original 2D motion picture sequence can be modified in different ways to create the left and right eye channels. In another aspect an original stereoscopic motion picture sequence may comprise a series of stereoscopic pairs, and the original left and right image streams are each also modified to include additional visual information, derived from the original left and right image streams, that enhances the stereoscopic sense of 3D depth. In this case, the original stereoscopic sequence may be a “genuine” stereoscopic sequence, e.g. obtained by stereoscopic cinematography (typically by simultaneously capturing two images of a subject from slightly differing viewpoints), a “synthetic” stereoscopic sequence, e.g. generated by computer graphic techniques, or a “pseudo”-stereoscopic sequence that is itself derived from an original 2D motion picture sequence (see, for example, WO2008/004005, EP1128679).

Further, similar methods may be employed for the purpose of converting an existing stereoscopic (two-channel) motion picture sequence into a single-channel, 2D motion picture sequence that provides a sense of 3D depth.

As used herein, the term “2D motion picture sequence” encompasses any kind of motion picture sequence comprising a single channel of sequential images. The term “3D-enhanced 2D motion picture sequence” refers to a 2D motion picture sequence that has been modified according to the first aspect of the invention.

As used herein, the term “stereoscopic motion picture sequence” encompasses any kind of motion picture sequence comprising a first channel of sequential images intended for viewing by one of a viewer's left and right eyes and a second channel of sequential images intended for viewing by the other one of the viewer's left and right eyes, so as to create the illusion of depth in the perceived image. The two channels referred to may be discrete, separate channels, or overlaid (multiplexed), as is well known in the art. The term “3D-enhanced stereoscopic motion picture sequence” refers to a stereoscopic motion picture sequence that has been modified according to the second aspect of the invention.

“Motion picture sequence” further encompasses sequences recorded and/or encoded in any medium and any format, including optical and electronic and analogue and digital media and formats.

Stereoscopic imaging is well known and will not be discussed in detail. As used herein, the term “stereoscopic” includes “genuine”, “synthetic” and “pseudo”-stereoscopy as discussed above.

The invention does not depend on any particular 3D display or viewing technology. 3D-enhanced 2D motion picture sequences in accordance with the invention may be displayed by any type of conventional 2D video or cinematic display and viewed without any artificial aids. 3D-enhanced stereoscopic motion picture sequences in accordance with the invention may be adapted for display/viewing using shutter glasses (such as LCD shutter glasses), circularly or linearly polarized glasses, anaglyph glasses etc., and “glasses-free” (e.g. autostereoscopic) 3D display technologies, as are well known in the art.

### BACKGROUND TO THE INVENTION

It is known that a pseudo-stereoscopic effect can be obtained from conventional 2D motion picture footage if the original footage is duplicated to provide two separate left and right channels and: (a) one of the channels is delayed in time slightly relative to the other and (b) the images of the respective channels are laterally displaced slightly relative to one another. For moving subjects within the image sequence, the slight differences in perspective between successive 2D frames provide the basis for approximate stereoscopic pairs when presented in this manner. This effect is enhanced by the lateral displacement of the right- and left-hand images. In this basic form, this known pseudo-stereoscopic effect (also sometimes known as “time parallax”) is of limited practical value and does not in itself enable a sustained and convincing 3D effect except in limited circumstances.

WO2008/004005 seeks to improve the quality of stereoscopic motion picture sequences synthesized from 2D motion picture in this way. In another aspect, WO2008/004005 further seeks to improve the quality of stereoscopic motion picture sequences, however the sequences are generated (e.g. by stereo cinematography, by CGI techniques—i.e. 3D computer modelling and rendering whereby stereoscopic image pairs are generated, digital image capturing and processing etc.).

Conventional stereoscopic imaging simply seeks to present each eye with a separate view of a scene that simulates the monocular view that would be received by each eye if viewing the scene directly. That is, it is a purely geometrical/optical approach concerned only with the optical input received by each retina. This approach can produce striking and convincing 3D images, but in reality it can provide only a very crude approximation of the way in which the 3D world is actually perceived by human beings. A real person does not stare fixedly at a scene in the way that a stereoscopic camera pair does, and does not stare fixedly at a cinema screen in a way that matches the projected stereoscopic images. Accordingly, extended viewing of conventional stereoscopic motion picture sequences can be disorienting, strain-inducing and ultimately unconvincing.

### SUMMARY OF THE INVENTION

The present invention arises from a recognition that human perception of the 3D world is a much more subtle and complex process than the simple combination of monocular images from each eye. In particular, the invention is based on the recognition that human binocular vision/perception involves the continual processing of overlapping “double images”, that from moment to moment are consciously perceived as double images to a greater or lesser extent as the focus of attention shifts around a scene.

In broad terms, the invention enhances conventional motion picture sequences (including 2D and stereoscopic sequences) by incorporating additional 3D cues into each frame (or each video field, in the case of interlaced video formats) of each channel in the form of additional image elements. In WO2008/004005, additional image elements of this broad type are referred to as “temporal shadows”. The temporal shadows in each frame are degraded and/or partially transparent representations of some or all of the image elements of the current frame, derived from one or more other image frames in the sequence of frames. In WO2008/004005, the temporal shadows included in the right eye version of one frame are typically derived from the left eye version of the same frame, or a closely adjacent frame from either channel, and vice versa. In the case of preferred 2D and stereoscopic conversion processes described herein, the temporal shadows are derived from frames that precede or succeed the current frame in time. The expression “temporal shadow” derives from this time-shifted origin of the temporal shadow images, but may refer to such images serving the same purpose of providing enhanced 3D visual cues, however they are derived.

Herein, the term “optical subcarrier” is used for convenience to refer to the additional “temporal shadow” information that is included in the 3D-enhanced version of the original 2D or stereoscopic sequence, by analogy to electromagnetic subcarrier signals as used, for example, in radio and television transmissions.

Clearly, this approach necessarily reduces the objective accuracy of the image presented in each frame in terms of what would be perceived instantaneously at the retina of each eye. Counter-intuitively, however, it is found that this basic idea provides the basis for a more satisfactory subjective 3D visual experience.

It is noted here that conventional scene transition effects employed in film or video editing, particularly dissolves, may be said to involve images from frames at the end of a first scene being included in images in the frames at the beginning of a succeeding scene. Such conventional editing/transistion techniques/effects are excluded from the scope of the present claims. Similarly, other instances in which images are overlaid in frames of motion picture sequences for creative purposes, rather than for the technical purpose of creating or enhancing 3D/stereoscopic effects, are likewise excluded from the scope of the claims.

The parameters according to which the temporal shadows are derived from certain frames and incorporated into other frames can be varied depending on, for example, the nature of the content of a particular sequence (for example, the speed and/or direction of motion of objects within a scene) and the particular subjective effect that is desired to be created by the author of the sequence, as shall be described below by reference to exemplary embodiments of the invention.

In accordance with one aspect, the present invention provides 3D-enhanced 2D and stereoscopic motion picture sequences incorporating optical subcarriers as described herein.

In accordance with other aspects of the invention, there are provided methods, and corresponding computer program products, for producing 3D-enhanced 2D and stereoscopic motion picture sequences incorporating optical subcarriers as described herein.

In accordance with still further aspects of the invention, there are provided data processing systems/apparatus for implementing methods of producing 3D-enhanced 2D and stereoscopic motion picture sequences incorporating optical subcarriers as described herein.

The various aspects of the invention, and further preferred, optional or alternative features thereof, are defined in the claims appended hereto.

Embodiments of the invention will now be described, by way of example only, with reference to the accompanying drawings.

### BRIEF DESCRIPTION OF THE DRAWINGS

FIG. 1 is a schematic block diagram illustrating an example of a data processing system architecture for use in accordance with the present invention.

FIG. 2 is a schematic block diagram illustrating a further example of a data processing system architecture for use in accordance with the present invention.

FIG. 3 is a diagram illustrating an example of a process of comparing two video fields for the purposes of the present invention.

FIG. 4 is a diagram illustrating an example of a process of generating a modified video field incorporating a temporal shadow image in accordance with the present invention.

FIGS. 5 to 14 are diagrams illustrating the relationships between original images and temporal shadow images;

FIGS. 15 to 18 are diagrams illustrating a notional clock face with a moving hand that is used to illustrate various types of optical subcarrier cycles according to preferred embodiments of the present invention;

FIGS. 19 and 20 are diagrams illustrating the motion of the notional clock hand in a sequence of video fields;

FIGS. 21A to 21H are diagrams illustrating a first optical subcarrier cycle type A1;

FIGS. 22A to 22H are diagrams illustrating a further optical subcarrier cycle type A2;

FIG. 23 is a graphical representation of the motion of a moving object between successive video fields and FIG. 24 is a similar graphical representation including representations of temporal shadows derived from preceding and succeeding video fields.

FIG. 25 is a graphical representation of the optical subcarrier type A1 in the same format as FIGS. 23 and 24;

FIG. 26 is a graphical representation of the optical subcarrier type A2 in the same format as FIGS. 23 and 24;

FIGS. 27A to 27H are diagrams illustrating a further optical subcarrier cycle type B1;

FIGS. 28A to 28D are diagrams illustrating a further optical subcarrier cycle type B1A;

FIGS. 29A to 29D are diagrams illustrating a further optical subcarrier cycle type B2;

FIGS. 30A to 30D are diagrams illustrating a further optical subcarrier cycle type B3;

FIGS. 31A to 31D are diagrams illustrating a further optical subcarrier cycle type B3A;

FIGS. 32A to 32F are diagrams illustrating a further optical subcarrier cycle type C;

FIGS. 33A to 33D are diagrams illustrating a further optical subcarrier cycle type D;

FIGS. 34 to 40 are a graphical representations, respectively, of optical subcarrier types B1, B1A, B2, B3, B3A, C and D in the same format as FIGS. 23 and 24;

FIGS. 41A to 41C are diagrams representing “time-reversed” processing of corresponding video fields of a stereoscopic video sequence.

FIG. 42 is a schematic representation of an optical set up for simultaneously recording the same scene using two cameras with differing operating parameters;

FIG. 43 is a diagrammatic representation of the processing of sequences recorded using the cameras of FIG. 42.

### DETAILED DESCRIPTION OF THE PREFERRED EMBODIMENTS

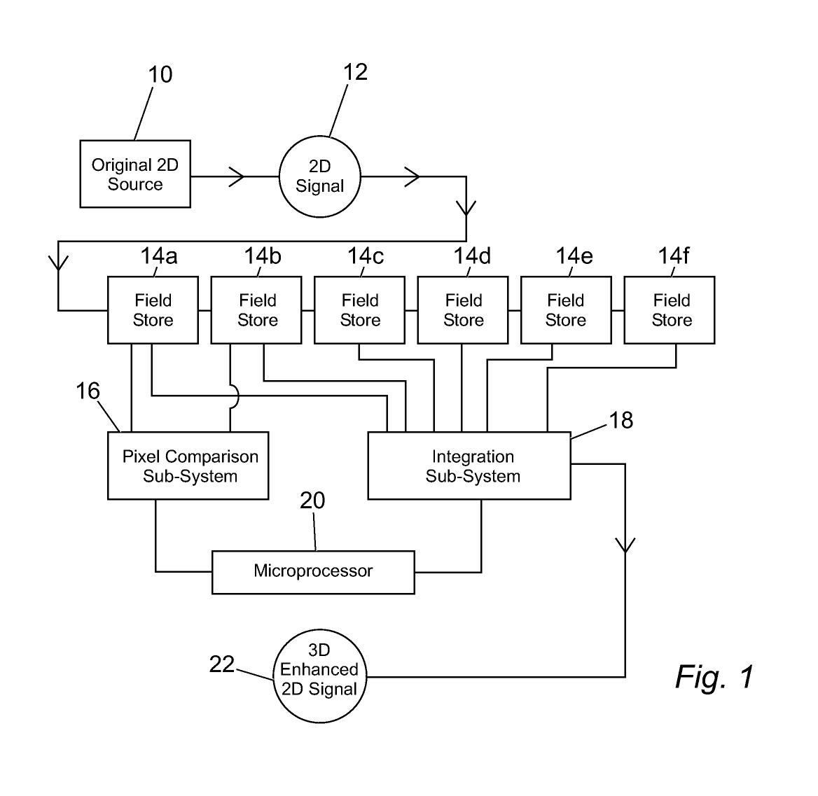

Firstly, examples of systems and methods will be described for the modification of original 2D motion picture sequences into 3D-enhanced motion picture sequences in accordance with the invention, with reference to an exemplary digital video processing system architecture as illustrated in FIG. 1 of the drawings.

This example presupposes the use of 2D source material in a video format comprising a sequence of image frames, each of which frames comprises an array of pixels divided into first and second fields of interlaced scan lines, as is well known in the art. The original source material may be in an analog format, in which case there would be an analog-digital conversion step (not illustrated). It will be understood that the illustrated system architecture is only one example, and that functionality of the illustrated system could be achieved by a variety of other means, implemented in hardware, firmware, software or combinations thereof. For example, the digital image processing required for the purposes of the present invention could be performed by means of a suitably programmed general purpose computer (this applies to all embodiments of the invention in which the motion picture sequences are represented digitally or are converted to a digital representation). Equally, it will be apparent that motion picture sequences having similar characteristics, in accordance with the present invention, may be generated in other formats, including electronic video formats having more than two fields per frame, progressive scan formats that do not employ interlaced fields, and film. While it is clearly desirable to automate the processing of source material (whether 2D or conventional stereoscopic material) to the greatest extent possible, typically using digital data processing, it can be seen that equivalent results could be obtained by digital or analog signal processing or by optical/photochemical means (in the case of film), with greater or lesser degrees of manual intervention (e.g. in an extreme example, digital image sequences could be processed manually on a frame-by-frame basis).

It is the purpose of the system architecture of FIG. 1 and the sequences of digital processing that it implements to take a standard 2D video signal and convert it into a 3D-enhanced 2D video signal, by creating an optical subcarrier from the original 2D signal and adding the optical subcarrier to the original 2D signal.

As shown in FIG. 1, the exemplary system architecture comprises a source (e.g. media playback device) 10 of an original 2D video signal 12. In this example, the signal 12 represents a sequence of 2D image frames, each frame consisting of two fields. The 2D signal 12 is input to a first set of serially connected field stores (memory modules, six in this example) 14a-14f. The first two field stores 14a, 14b are each connected to a pixel comparison sub-system 16. All of the first series of field stores 14a-14f are connected to an integration sub-system 18. The pixel comparison sub-system 16 and the integration sub-system 18 are in turn connected to a microprocessor 20. The integration sub-system 18 generates as output a 3D-enhanced 2D signal 22, which may be encoded in any desired format and recorded in any desired medium. The 3D-enhanced 2D signal 22 corresponds to the original 2D signal 12 to which the optical subcarrier has been added; i.e. in which each field of each frame has been processed and modified by the integration sub-system 18 as shall be described further below.

The result of this processing is to introduce spatial three dimensional cues, into a 2D image stream, allowing the viewer to appreciate a sense of enhanced depth, whilst looking at these processed images on a normal television or computer screen or the like (including projection display systems), without the need for any 3D viewing aids such as 3D glasses.

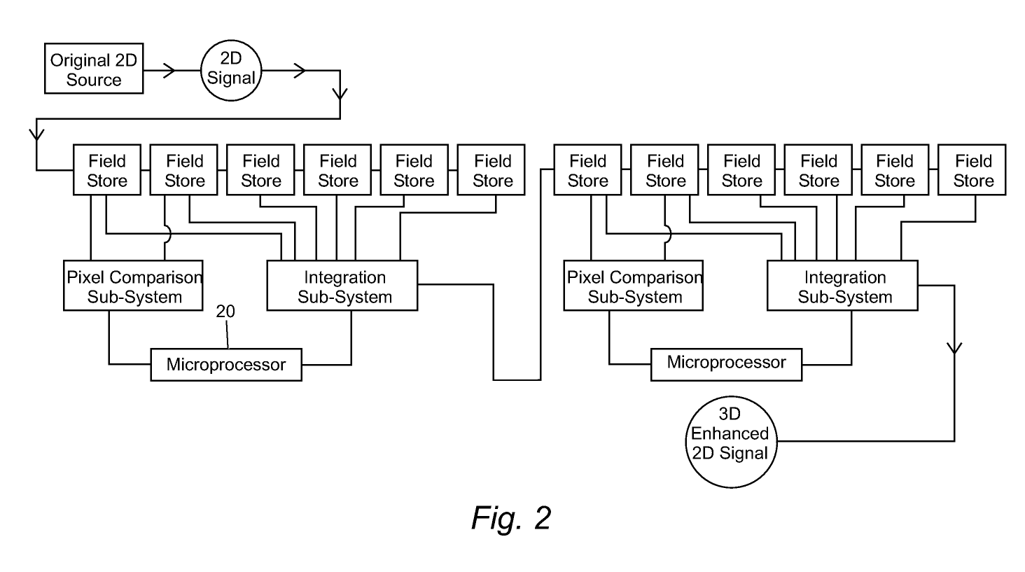

FIG. 2 illustrates how a system architecture such as that of FIG. 1 may be extended, in effect daisy-chaining multiple “copies” of the system, to provide greater processing flexibility and/or efficiency.

Referring in more detail to the processing scheme, the purpose of the field stores 14, pixel comparison sub-system 16 and integration sub-system 18, in combination with the microprocessor 20, is to enable the content of individual video frames to be sampled, for the video field samples to be processed, and for the processed samples to be blended with original video fields, such that each original video field is modified to include one or more temporal shadows derived from preceding and/or succeeding video fields.

It will be understood here that for the purposes of the present embodiment, the term “temporal shadow” means at least one sample from at least one video field that has been processed for blending with a preceding or succeeding video field.

As shall be discussed and explained further below, there are several parameters associated with the sampling, processing and blending of the temporal shadows. Generally speaking, the values of these parameters may be varied by a user of the system within and/or between individual motion picture sequences to control the visual 3D effects obtained in a final motion picture presentation.

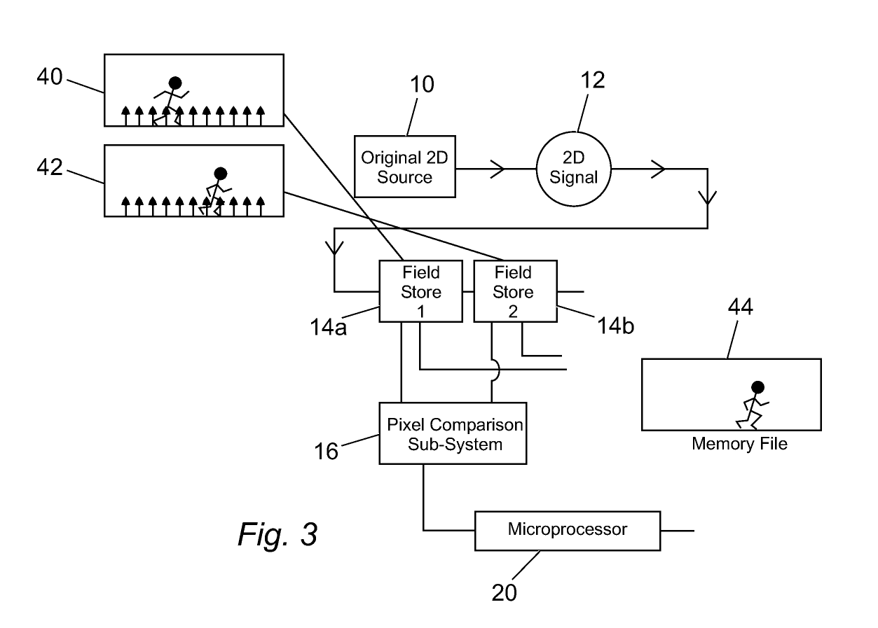

In the example of FIG. 1, and with further reference to FIG. 3, field stores 14a and 14b capture two successive video fields 40 and 42. The pixel comparison sub-system 16 and microprocessor 20 process the contents of the field stores 14a and 14b to determine which pixels have changed between the successive fields; i.e. to detect moving objects within the scene represented by the video fields. Algorithms for the detection of motion in video streams are well known in the art and will not be described in detail herein. The difference between the two fields is stored as a memory file 44 in one of the other field stores 14c-f. In this example, the first field 40 is the reference field and the differences in the succeeding field 42 are stored in the memory file 44. In this case the image is of a figure running against a static background, and the memory file represents the figure in the second field 42 as it has moved since the first field.

The number of field stores 14 in the first set of field stores may be varied to accommodate the required processing. In particular, more than two field stores 14 may be connected to the pixel comparison sub-system 16 to enable comparisons between multiple fields and/or fields that are not immediately adjacent in the video stream.

A first parameter, then, to be considered in generating a temporal shadow from a particular frame is the extent to which a pixel must move between fields before it is included in the memory file, referred to herein as the pixel displacement. For the purposes of the present invention, one or more threshold values or ranges may be set for the pixel displacement, and the values of other parameters associated with the temporal shadow may be related to the pixel displacement threshold(s)/range(s). As shall be further explained below, more than one memory file may be created from the comparison of the same pair of fields, each corresponding to a different displacement threshold/range and stored in one of the field stores 14c-14f. In this way, each memory file will represent objects or parts of objects in one field that have moved by different amounts relative to the other field. These memory files may then be processed to create either separate temporal shadows or a single composite temporal shadow derived from one of the pair of fields for inclusion in the other one of the fields.

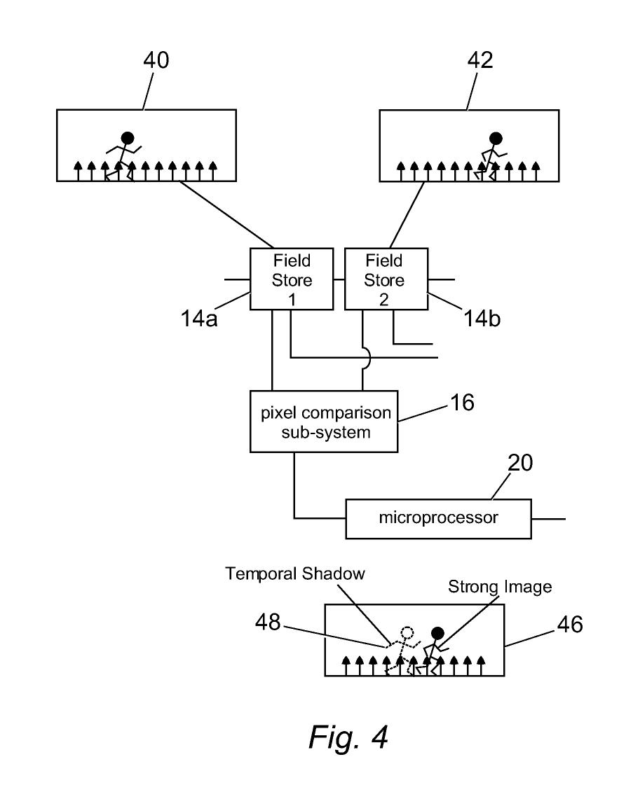

In a simple example, where a single memory file is created on the basis of a single displacement value or range, the content of the memory file is further processed to create the temporal shadow image prior to this being blended with the “current” field (i.e. the reference field against which the other field was compared to create the memory file from which the temporal shadow was derived). This is illustrated in FIG. 4, which shows a processed video field 46 incorporating a temporal shadow 48. In this example, the processed field 46 is based on original field 42 and the temporal shadow is derived from preceding field 40. That is, a memory file is created from the difference between fields 40 and 42, using field 42 as the reference field, and the memory file is processed to create the temporal shadow image which is then blended with the content of the reference field (the “current” field) 42 to create the processed field 46.

In the preferred embodiments of the invention, the processing of the memory file comprises a degradation or de-resolution process, whereby the clarity and/or sharpness of the image represented by the memory file is reduced. A suitable degradation or de-resolution effect can be achieved by means of any of a variety of well known digital graphics filter algorithms, suitably including blurring techniques such as Gaussian blur or noise-addition techniques such as effects that increase the apparent granularity of an image. Such processes will be referred to hereafter simply as “degradation”.

The degree of degradation is a second parameter associated with the temporal shadow. As previously indicated, the value of this parameter may depend on the pixel displacement threshold/range applied in deriving the memory file. Typically, the degree of degradation will increase with increased displacement, so that the temporal shadows for fast moving objects with greater displacements will be degraded to a greater extent than the temporal shadows for slow moving objects with lesser displacements.

The temporal shadow, being a degraded version of the image represented in the memory file, is blended with the reference field to create the final processed field 46. In preferred embodiments, the blending involves applying a degree of transparency to the temporal shadow. In computer graphics, such blending is often referred to as “alpha compositing”. Such techniques are well known in the art and will not be described in detail. The degree of transparency is referred to as the alpha value, i.e. a value between 0 and 1, where 0 represents full transparency and 1 represents full opacity.

The alpha value is a third parameter associated with the temporal shadow and again may vary depending on the pixel displacement threshold/range applied in deriving the memory file. Typically, the degree of transparency will increase (the alpha value will be reduced) with increased displacement, so that the temporal shadows for fast moving objects with greater displacements will be more transparent than the temporal shadows for slow moving objects with lesser displacements.

The degree of degradation and the degree of transparency may be interdependent; i.e. for a given pixel displacement the degree of degradation may be reduced if the transparency is increased. It will be understood that the optimal values of the pixel displacement, degradation and transparency parameters will depend on the content of the motion picture sequence and the desired visual effect. Accordingly, particular values for these parameters are not given here and suitable values for particular applications of the present invention can readily be determined empirically on the basis of the teaching provided herein.

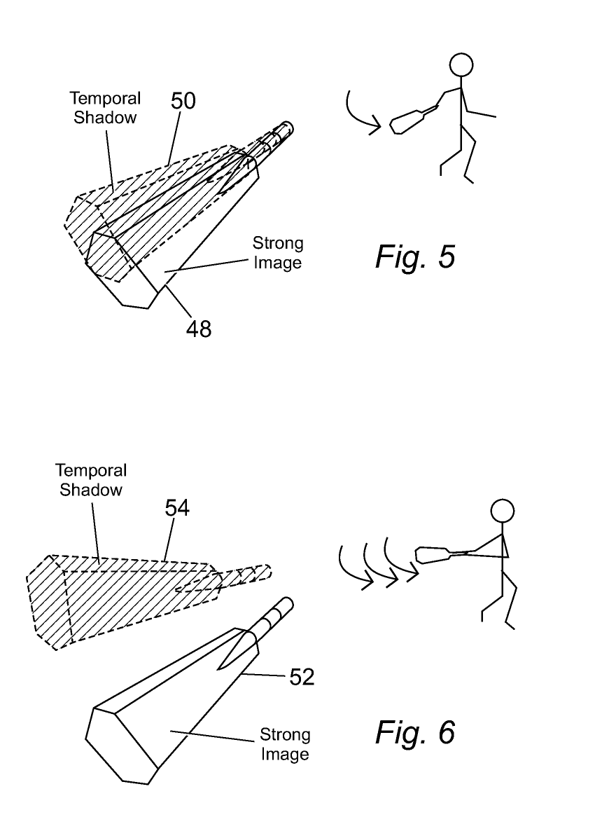

The result of the processing described thus far is that each processed field now comprises a combination of at least two images: a strong, original image (primary image content) and one or more weak de-resolved (degraded) images—the temporal shadow(s). The strong image is an original stream image, and the weak image is a degraded image of those pixels from the immediately preceding (or succeeding) image that moved more than a specified amount or by an amount in a specified range. As a result objects within the final composed image that are slow moving will be represented as a clear object or slightly elongated (by the addition of a relatively strong/clear temporal shadow—see FIG. 5, showing the outline 48 of the original image of an object and the temporal shadow 50 derived from the preceding video field), but all those that are fast moving will appear either greatly elongated or in two positions: one position clearly defined, and the other degraded (e.g. slightly granular) and/or partially transparent (see FIG. 6: original object image 52, temporal shadow 54).

In this description reference is made to a composite field consisting of one strong image and one temporal shadow. The processes may also create composites of one strong image and two or more temporal shadows, and of a single strong image—as will be illustrated later.

Each processed (composed) field, when now looked at on a field-by-field basis, seems slightly less clear and in focus, as some parts of the image now have a slightly less distinct outline, and in the case of objects in rapid motion, they will clearly appear in two positions, albeit one slightly less distinct than the other. (It will of course be virtually impossible to detect this when the sequence of fields is played back, typically at between 50 to 60 fields each second.)

This has the effect of giving moving objects a different profile; e.g. a longer (elongated) profile. This profile is still ‘true’, in that it is transformationally correct, when considered three-dimensionally, as shall now be discussed.

Importantly, this process generally has the effect of giving objects a double edge outline. As discussed further below, this resulting mixture of doubled edges, thickened edges, edges with varying degrees of separation, and single edges, corresponds with the complex (and slightly confusing and de-resolved) image that in reality, both of our eyes, jointly, present to the occipital lobes of the brain when viewing a real 3D scene.

Although these slightly granular, superimposed, de-resolved images (the temporal shadows), have the effect of lowering the clarity and resolution of each video field, when considered two-dimensionally, they also do something much more important and very useful to the overall intention of the processing: they introduce three dimensional information into the two dimensional image of each video field, as follows.

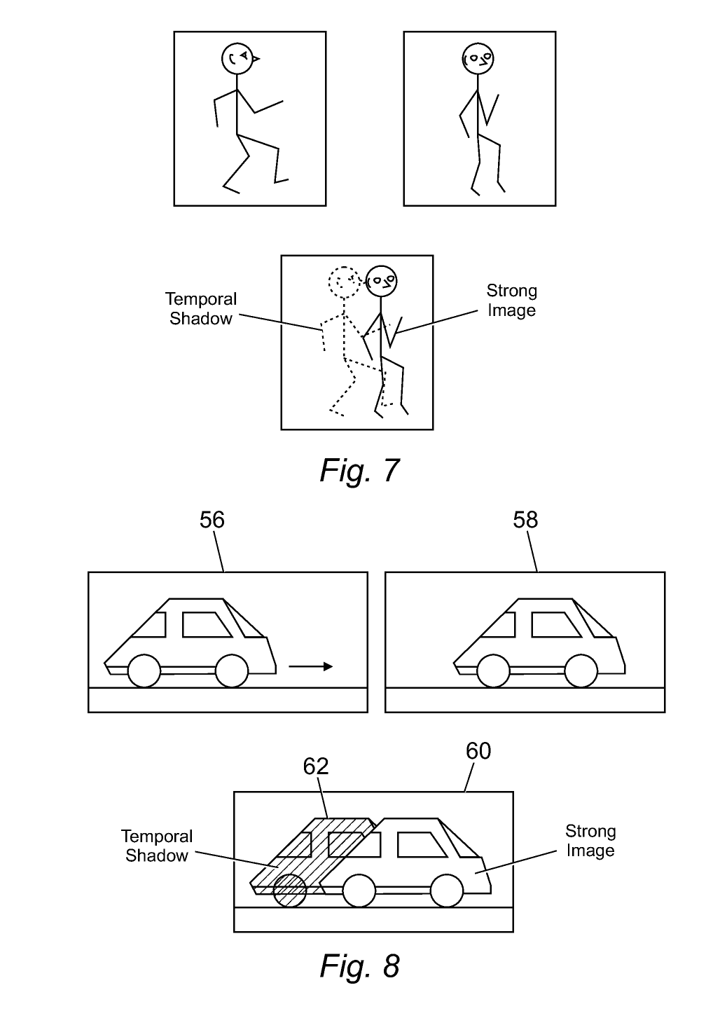

The ‘temporal shadows’ are images of their counterpart objects in the ‘strong’ image, but nearly always have a degree of rotation about them. So they represent a slight rotational transformation upon the original (see FIG. 7, showing examples of rotational transformation in successive images of a moving figure). However, unlike a true stereoscopic representation, the planes of the various rotations of the objects in each field are not uniform.

So the processed field now contains additional information, at the expense of a slight drop in clear resolution, but now includes rotational information that gives a slightly different additional (second) perspective of the object. So between each object and its temporal shadow, there are now two perspectives of the same object, and through these two perspectives, we have very important rotational 2D-parallax.

As well as the slight rotational information, the processing gives objects blurred edges, and double edges (by the combination of the temporal shadow and strong image), some with clear edge displacement, and some objects having a normal single outline.

This mixture of single edges and displaced edges replicates the real three dimensional viewing experience as it is properly understood by reference to the further discussion below. The human brain interprets this slightly de-resolved image as containing important information not present in the 2D original: depth information. The double edges trigger the brain's generation of a sense of spatial displacement between double edges and single edges, and between double edges and wider double edges.

The complex mixture of blurred edges, double edges and clear single edges contains depth information that the brain will not ignore.

All 3D, stereoscopic imaging involves a rotational parallax between two pictures taken from two similar, but slightly displaced reference points, with one of these two images going to each eye; in the case of pseudo-stereoscopic 3D (that is 3D image pairs created from sequences of single 2D images; i.e. from a single reference point) the strong image would go to one eye and the temporal shadow to the other eye, and when this is the case a slightly stereoscopic effect can be achieved.

So rotational parallax has always been found in both stereoscopic and pseudo-stereoscopic images, where one of the two images goes to one eye and the other goes to the other eye. The present invention provides a new class of pseudo-stereoscopic processing, in which a new category of rotational parallax is created between two unequal images (strong image and temporal shadow) and in which both of these images are sent to one eye and both are sent to the other eye; i.e. they are contained within a single 2D image.

A strong image and at least one temporal shadow are combined in each single video field (with some exceptions in which some fields contain only a strong image, as described below), and when we look at any sequence of successive video frames that have been processed in this way, and in particular look at the sequence of successive video fields within each frame, we see, for example, that the first field (the odd field) has a temporal shadow accompanying fast moving objects, so we can clearly see the strong image and the temporal shadow in such cases, and when we look at the next video field within the frame (the even field), we see that the temporal shadow is now in the position that the strong image was in before. Then, in the next field—the first (odd) field of the next frame—the temporal shadow is also in the position that the strong image was in—in the last (even) field of the preceding frame. And so it is as though there is a slight ‘after-image’—see FIG. 8, showing a first field (n), 56, a succeeding field (n+1) 58, and the processed version 60 of the second field 58 incorporating a temporal shadow 62 derived from the first field 56.

Those objects within an image that are moving at still greater speed have a greater distance between the strong image and the temporal shadow. The temporal shadow precedes the strong image (i.e. it is derived from the preceding field, in this example). As a result, the greater the speed of the object within the image, the greater its ‘displacement-footprint’ within the processed video field image.

It should now be clear that the greater the “displacement footprint”, the more pronounced the double edge will be in the processed image, and this helps establish a complex scene with multiple planes, as understood by the brain. Often these double edges will only be consciously discernible by pausing a frame and looking at individual objects and their pixels. At normal playback speeds they cannot clearly be seen or detected, but at the higher centres in the brain they are registered, and they inform the brain that the image has many planes and therefore has volume.

Those objects within the image that are moving slowly have little or no separation between the strong image and the temporal shadow, and they almost share the same boundaries, with the temporal shadow image giving an additional edge, a slightly elongated or altered shape to the image.

The displacement footprint not only has a double image—which is a key cognitive cue for the position of the object within the perceived volume—but also contains slight rotational parallax within it, and this can also supply the brain with cognitive cues as to the shape and volume of the object itself.

As previously discussed, a first parameter (variable) that needs to be determined at the outset of the processing of a particular sequence is the degree of displacement that must be registered of each pixel, from one video field to next, before it is represented in the memory file and subsequently modified, prior to being added to the adjacent video field as the temporal shadow. In other words: how fast must an object be moving before it is created as a temporal shadow in the following image, and how slow must an object be moving before it is not? How the displacement parameter is set will depend upon the subject matter, and the intentions of the director of the work.

Throughout the description of this embodiment, all digital processing is on a field by field basis. Reference is made to frames because, in interlaced scan systems, fields are grouped into frames (usually two fields per frame), but more generally the present system is applicable to discrete images that are arranged time sequentially, regardless of the format. In particular, references to fields in the context of interlaced video formats in the present embodiment will be understood to be generally applicable, e.g. to frames in the context of non-interlaced (e.g. progressive scan) formats. The accompanying claims refer to “images”, which encompasses both complete frames and also individual fields, two or more of which may constitute a complete frame.

Generally speaking, the 3D enhancement techniques described herein are most effective when the temporal shadow content varies at a relatively high frequency; i.e. 50 Hz or 60 Hz for interlaced video formats with a frame rate of 25 or 30 frames per second and two fields per frame. If the techniques are applied on a frame-by-frame basis (rather than field-by-field), so that the “temporal shadow frequency” is equal to the frame rate, then a higher frame rate such as 50 or 60 frames per second is preferable. As discussed further below, it may be desirable for the temporal shadow content to vary at a higher frequency than the strong image content, as occurs in the case when the techniques are applied on a field-by-field basis to interlaced video, and this effect may be simulated in non-interlaced formats by including two successive copies of each frame in the image stream, such that different temporal shadow content is included in each copy of each frame—with the final sequence being played back at twice its “normal” speed (i.e. so that the two successive copies of each frame with differing temporal shadow content are displayed in a single “frame period”).

As also discussed above, second and third parameters/variables determine the state of the temporal shadow: the degree and character of its degradation and de-resolution, and the degree of its transparency when combined with the strong image (current/reference field/frame).

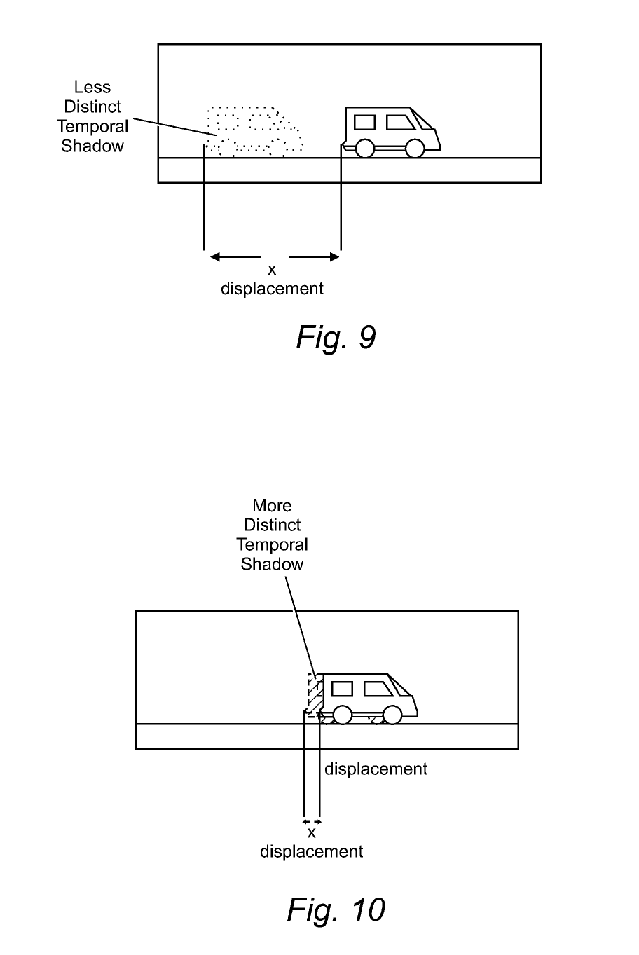

The greater the displacement in its position from one video field to the next, the more degraded is the temporal shadow rendered to be, and the less distinct and more transparent is its image in the video field (see FIG. 9). Therefore the smaller the displacement footprint (see FIG. 10), the more distinct is the outline and combined image (with the temporal shadow). But this is not always the case: in some settings, the degree of degradation may be small—i.e. the temporal shadow approximates the strong image in clarity—and this degree of degradation may be constant, regardless of the degree of displacement of the object from one field to the next.

There is a subliminal requirement in the brain's detection of the temporal shadow. The temporal shadow, should not draw great attention to itself in the image as seen by the eye, but it should be detected by the brain when the full image is being analysed at a deeper cognitive level within the occipital lobes, hence its fleeting and granular nature. The temporal shadow (or shadows when there are two of them in the image) is intended only to be fully detectable on a freeze-frame analysis.

Having described the general principles and details of the processing, and a number of possible variations thereof, there will now be described a number of basic options that may be employed within the processing

As described thus far, the temporal shadow content is selected based primarily on the degree of displacement of objects between frames. As a special case of this, the displacement parameter may be set to zero, so that the temporal shadow for the current field is derived from the entire image from a preceding or succeeding field. The output in this case is a single channel series of video fields in which all fields comprise a composite of the current field and temporal shadow content that comprises a degraded/partially transparent version of the whole content of a preceding or succeeding field. Viewed on a field by field basis, fast moving objects have a discernible coloured shadow, with slower moving objects having a slightly coloured, granular edge.

Inherent in the processing is the option whether the temporal shadows are derived from succeeding fields or from preceding fields. Given a process that derives temporal shadows from preceding fields, an equivalent process that derives temporal shadows from succeeding fields can be accomplished in the same way as for preceding fields but by processing the videostream playing back in reverse, or by using the field stores 14 to create a sufficient buffer for processing the necessary fields.

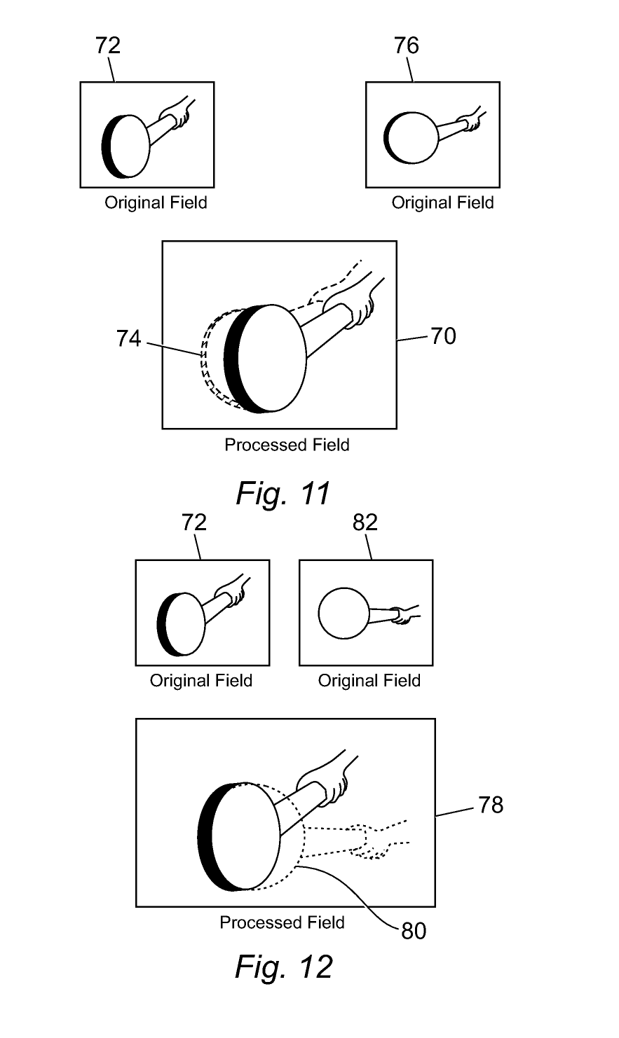

As a result, when the processed sequence is played in the correct direction, each temporal shadow now matches the strong image of the succeeding video field. This is illustrated in FIG. 11, as compared with FIG. 12. FIG. 11 shows processed field 70 corresponding to original field 72 and including temporal shadow 74 derived from preceding field 76, while FIG. 12 shows processed field 78 corresponding to original field 72 and including temporal shadow 80 derived from succeeding field 82.

When the temporal shadow is derived from a succeeding frame, it “leads” the strong image on each frame. This creates a subtle difference compared with a process in which the temporal shadow is derived from a preceding frame and thus “follows” the strong image on each frame and, depending upon the camera angle relative to the onscreen images, may produce a more satisfactory result. In the case where the temporal shadow content is derived from succeeding fields, the temporal shadows represent “where the object is going”.

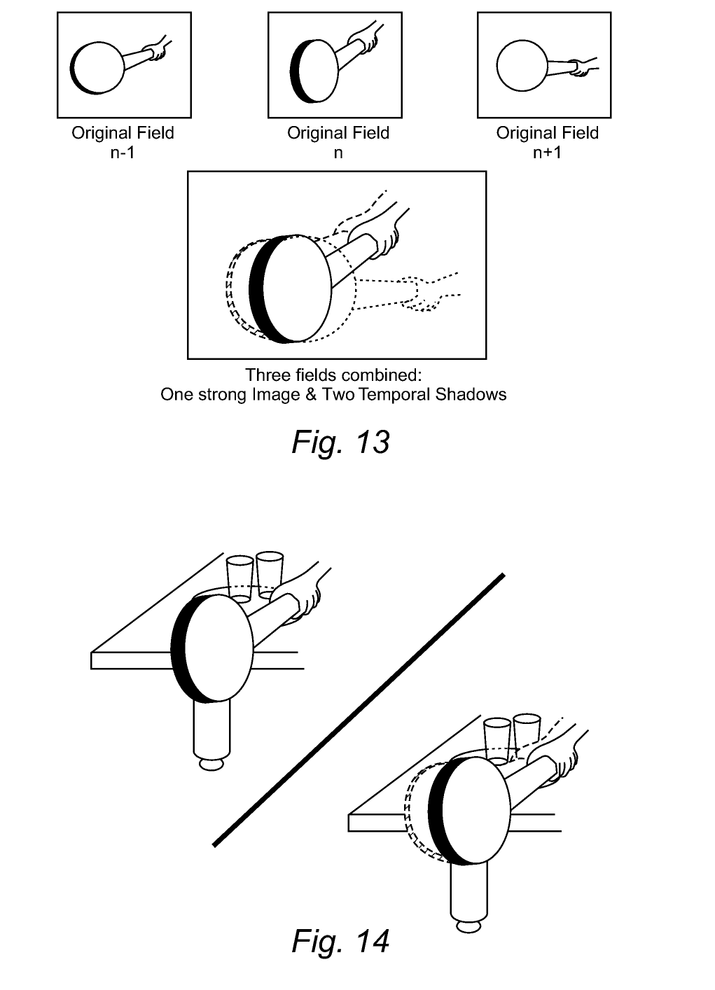

As a further option, a field may be processed so as to include temporal shadow content derived from both a preceding field and a succeeding field. This has the effect of increasing the image area of the displacement footprint, by creating an image based on at least three fields as shown in FIG. 13. The processed field here includes one strong image, from the current field, and two temporal shadows, one from the preceding image and one from the succeeding image.

This may be referred to as a Bi-Directional Occlusion transformation (BDO): it allows all objects within the image to superimpose and distance themselves psuedo-stereoscopically from all of those objects behind them, and is a key transformation. In this case two temporal shadows now sandwich the strong image, both leading and following the strong image on each frame.

The effect of these processes and variants is to introduce additional three-dimensional information into a flat, two-dimensional image, in a way that is quite counter-intuitive: from an objective standpoint, they degrade the image, but from a subjective/perceptual standpoint, they add resolution and “understanding” to it.

The system architecture of FIG. 1 can easily be adapted for the purposes of processing temporal shadows from multiple fields for inclusion in a current field, either by the duplication or modification of the relevant components/modules, enabling two copies of the original 2D signal 12 to be processed in parallel, or by providing suitable storage means for storing a first copy of the output 2D signal 22 while a second copy of the original signal 12 is produced.

One other feature of the processing may be highlighted.

By increasing the displacement-footprint, which is now effectively the new image of every object that is moving above a certain speed (always relative to the camera), the degree of occlusion—the ‘overlap’ between these objects and those objects behind them, and therefore farther from the camera—is increased.

This increase in the displacement footprint is particularly enhanced in the bi-directional occlusion (BDO) transformation described above.

Those objects that are farther away are, in by far the majority of cases (but not always), moving at a slower velocity relative to the camera.

As a result, the degree of overlap is increased and this, the degree of occlusion, is one of the key contributors to our understanding of the three dimensional world. So by increasing the degree of occlusion, we are adding further to the three dimensional depth cues that are present in a two-dimensional picture or video field (see FIG. 14, which provides a comparison between an original image and the same image incorporating a temporal shadow from a succeeding field).

The processes as described thus far are similar to processes described in WO2008/004005, producing a modified two dimensional picture that has significant differences from the original. The processes that derive temporal shadows on the basis of the displacement of objects between fields produce a picture that has one or more temporal shadows, visible at specific sites within the image, and increase the degree of occlusion. The special case of using an entire field as the basis for a temporal shadow produces a “global” temporal shadow of varying ‘regional magnitude’ throughout and across the entire image.

Each processed image has—when viewed two-dimensionally—a slightly lower resolution than the original unprocessed image that it was derived from (in fact each processed image is derived from at least two or three original unprocessed images—apart from certain instances, described below, where unmodified original fields are alternated with modified fields containing temporal shadow elements), but it does have additional information. The resolution loss is not due to ‘noise’, and when viewed at normal playback speed the added information results in the viewer receiving cognitively a much higher resolution, since depth-enhanced pictures always contain much more cognitive information than two-dimensional equivalents.

In WO2008/004005, however, these types of process are used in the context of producing pseudo-stereoscopic motion picture sequences having left- and right-eye channels and requiring the use of suitable stereoscopic display technologies. The present invention makes use of and modifies these processes for the purpose of producing 3D-enhanced 2D motion picture sequences that comprise a single channel that can be displayed by conventional 2D display technologies and viewed without any artificial viewing aids. The invention further applies these modified processes for producing 3D-enhanced stereoscopic motion picture sequences.

For the purposes of the present invention, one of the important aspects of the transformations produced by these processes is the ability to supply the brain through both eyes simultaneously with information that it normally needs to receive separately through each eye. This is why the techniques described herein allow 3D depth to be seen by unaided viewing of a single 2D visual display.

The brain must still be persuaded—or rather allowed to believe—that it is seeing two images simultaneously, and that they are each coming to it through different eyes. The present techniques achieve this by supplying the different images to both eyes, but cyclically and not simultaneously. The different “stereoscopic” views, are effectively time multiplexed into the image stream.

In its preferred embodiments, the present invention employs repeating cycles of combinations of strong and temporal shadow image content from (usually) immediately adjacent fields or from closely adjacent fields, which are used, in effect, to embed an “optical subcarrier” into an original 2D motion picture sequence.

Exemplary embodiments of these “optical subcarrier cycles” will now be described.

In this embodiment of the invention, a set of nine different optical subcarrier cycles (hereafter referred to simply as “cycles”, for brevity) are applied selectively to original 2D sequences. Each cycle type has a number of variable parameters. The selection of appropriate cycles and cycle parameters to be applied to particular sequences is partly subjective, but a number of objective criteria can be identified such that the selection and application of the cycles may be automated, at least in part, by means of suitable video-analysis algorithms. Cycle selection may be based principally on the basis of motion/speed detection, but image brightness and contrast are also relevant factors, at least in some cases. Cycle selection may be based on combinations of such image parameters.

Each cycle produces a series of processed (“new”) fields (NFn), each of which includes at least a “strong image” (primary image content) from the corresponding original field (OFn) of the original 2D image stream. In the case of certain cycles, (B1, B1A, B3 and B3A as described below), alternate fields contain only the strong image—i.e. the current, unmodified field. In all other cases, each field includes at least one temporal shadow image from either a preceding original field (OFn+1) or a succeeding original field (OFn−1), or both.

The cycles each produce sequences of blended and specifically timed images that have the effect of convincing the brain that it has received two correct stereoscopic views—each one through a separate eye—thereby allowing the brain to generate a true sensation of 3D depth from a single 2D display. Each cycle is repeated until it is supplanted by another cycle type from the set of available cycles, or has one of its parameters modified, and the new or modified cycle repeats until supplanted or modified, and so on.

The nine cycle types are:
Cycle A1—a four field cycle.
Cycle A2—a four field cycle.
Cycle B1—a four field cycle.
Cycle B1A—a two field cycle.
Cycle B2—a two field cycle.
Cycle B3—a two field cycle.
Cycle B3A—a two field cycle.
Cycle C1—a three field cycle.
Cycle D1—a two field cycle.

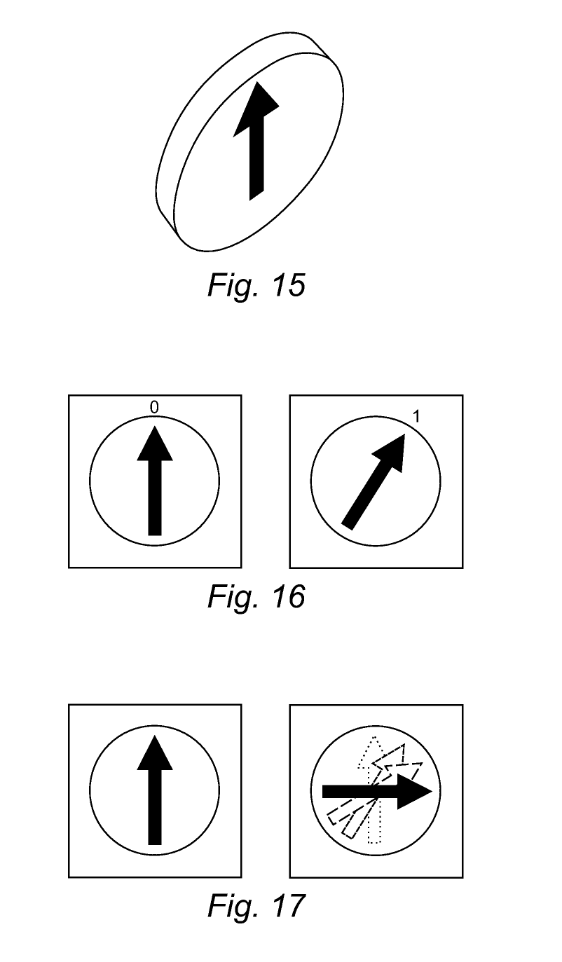

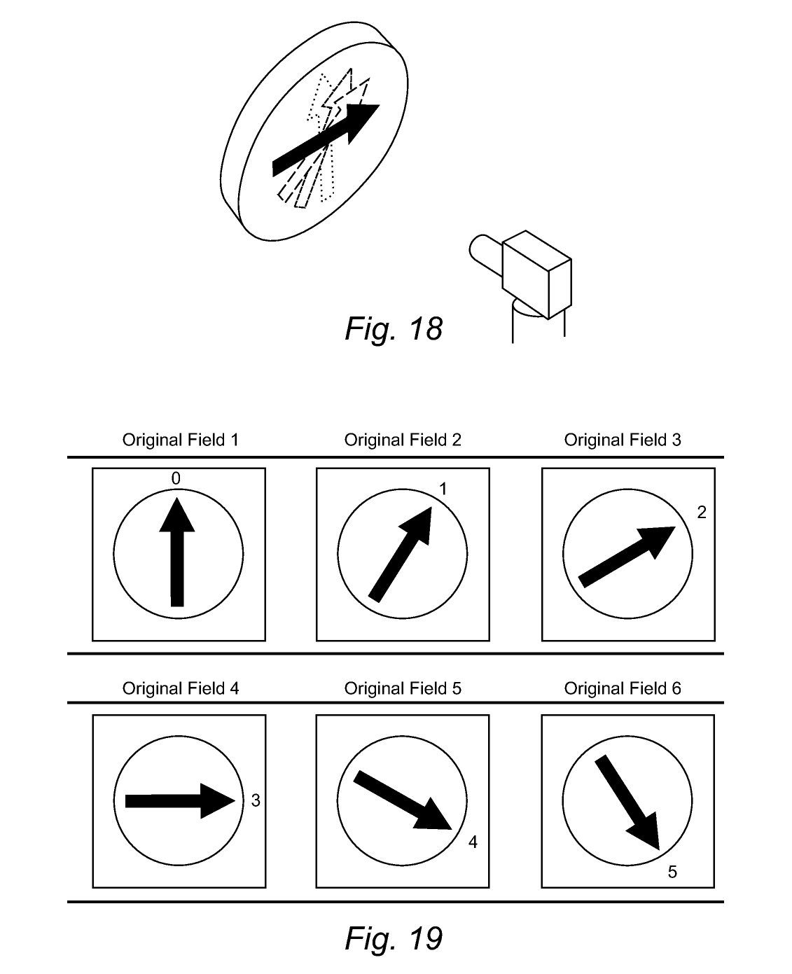

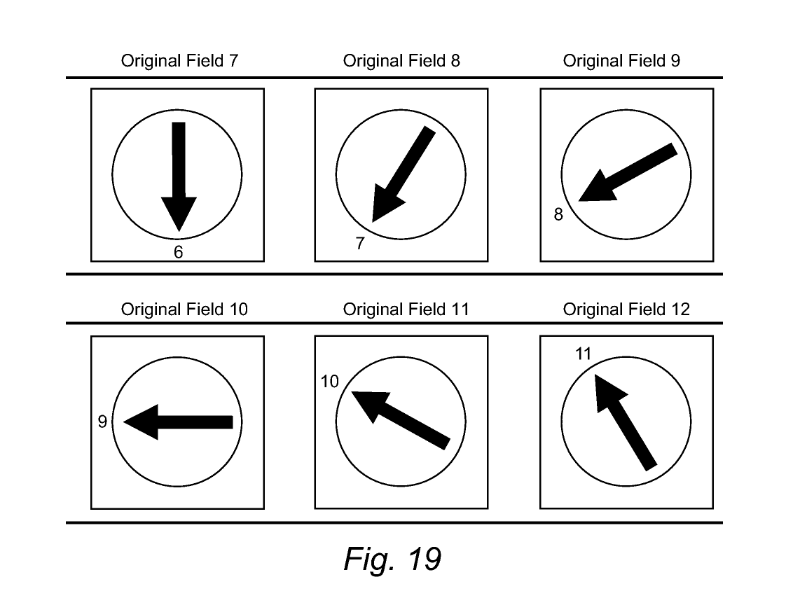

Each of these cycle types will now be described in detail. For the purpose of illustration, consider an image sequence that consists solely of the solitary hand of a ticking clock (see FIG. 15)—such that on each movement of the hand it travels from 12 o'clock to one o'clock, from one o'clock to two o'clock, etc. and each movement occurs after one video field duration has elapsed: i.e. for a video sequence with a 25 frame per second frame rate and two fields per frame, each movement occurs after one fiftieth of a second (see FIG. 16). The hand thus goes from the 12 o'clock position to 3 o'clock in 3/50th of a second (see FIG. 17) and the hand spins around four times in almost one second, so as to be almost a blur when seen by the naked eye. However when filmed by a camera (see FIG. 18) it produces a clear image on each field duration exposure, see FIGS. 19 and 20.

The clarity of such images is helpful, for although unrepresentative pictorially of the normal range and content of images they allow a useful and graphic simplification of what each cycle does to the original image. Note that the accompanying Figures illustrating the cycles as described below are diagrammatic and intended only to illustrate the relative content of original and processed fields. In particular, they are not intended to represent any particular degrees degradation or transparency of the temporal shadow components, or specific intensities of the strong images relative to the temporal shadow(s).

In practical applications of the cycles described below, it will be understood that, for any particular set of original fields, the actual content of the temporal shadow images will be determined on the basis of the criteria discussed above—particularly the degree of displacement of objects between fields, which in turn determines the degree of degradation and/or transparency of the temporal shadow image. The temporal shadow derived from any particular field may itself be a “composite” in which different processing has been applied to slower moving and faster moving objects.

In these embodiments, the temporal shadow content for a current new field NFn corresponding to an original field OFn is derived from a single original field (field OFn−1) that immediately precedes the current field and/or a single original field (field OFn+1) immediately succeeds the current field. In alternative or additional embodiments, the temporal shadow content may be derived from fields that are not immediately adjacent to the current field; e.g. for a current field NFn, the temporal shadow content may be derived from preceding field OFn−2 and/or succeeding field OFn+2. Further, the temporal shadow content may be derived from more than one preceding field (e.g. from fields OFn−1 and OFn−2) and/or from more than one succeeding field (e.g. from fields OFn+1 and OFn+2). That is, it will be understood that similar cycles could be implemented in which temporal shadow content is derived, for example, from single fields/frames that are not immediately adjacent or from multiple (immediately or closely) neighbouring fields that precede and/or succeed the current field. In practice, temporal shadow content is unlikely to be derived from fields/frames that are more than a few fields/frames away from the current field/frame except in unusual circumstances.

In all cases, the basic process for generating each new processed field NF# from a current original field OF# is as follows:

a. Determine whether the processed field is to include any temporal shadow content. If not, the processed field NF# will be identical to the original field OF#.
b. If the processed field is to include temporal shadow content, determine which other preceding and/or succeeding original field(s)—e.g. preceding field OF#−1 and/or succeeding field OF#+1—the temporal shadow content is to be derived from.
c. Process each other field identified in step b to determine a set of pixels that are to comprise the temporal shadow content from that field. The pixels to be included in a particular temporal shadow image are selected, primarily, on the basis of displacement between successive fields. Each other field will yield at least one such set of temporal shadow pixels. A single other field may yield more than one set of temporal shadow pixels, the different sets having been selected according to different criteria as previously described.
d. Process each set of temporal shadow pixels to degrade the image represented by the set of pixels by the appropriate degree and/or to apply the appropriate degree of transparency. Different degrees of degradation and/or transparency may be applied to different sets of temporal shadow pixels on the basis of different criteria as previously described. The degrees of degradation and transparency are determined, primarily, on the basis of displacement between successive fields. Each temporal shadow thus has an “inherent” degree of degradation and transparency.
e. Blend the processed sets of temporal shadow pixels with the current original field OF# according to the required relative intensities to produce the new field NF#.

As previously discussed, “transparency” may be expressed as an “alpha value”, and might also be thought of as a “blending factor”. That is, when two images are blended together, the final pixel value of each pixel is determined from the pixel values of the corresponding pixels and the respective blending factors of the two images.

When a strong image and temporal shadow(s) are blended in a new field, their relative intensities are also “blending factors” that determine the way in which corresponding pixel values of the strong image and the shadow(s) are combined to produce the final pixel value for each pixel. These blending factors modify the “inherent” transparencies/alpha values/blending factors of the strong image and the temporal shadows.

Strong images can be regarded as having inherent alpha values of 1—i.e. opaque—while the inherent alpha values of temporal shadows are variable depending on the criteria according to which they were produced.

When a strong image and a temporal shadow are blended in a new field, the pixel values of pixels in the new field are the same as for the original field of the strong image, except where they overlap with pixels of the temporal shadow.

Various types of blending algorithm are well known in the art and will not be described in detail herein. The invention is not limited to any particular blending algorithm. In the following description of the optical subcarrier cycles, the relative “intensities” of the “strong image” on the one hand and the “temporal shadows” on the other hand refers generally to the ratios in which the different pixel values are blended to obtain a pixel value for the new field.

The particular ratios stated are merely indicative of typical values that are likely to be appropriate for each of the cycle types. In practice, the relative intensities will preferably be manipulated until the temporal shadows are clearly present when viewed in freeze-frame, but not consciously detectable in normal playback.

In any particular instance the most important determinant may be the subjective appraisal of the editor/operator, as they manipulate the relative intensities. Broadly speaking, it is preferable in general for the temporal shadows to have the highest relative intensities that they can without becoming too detectable in normal playback, or the lowest relative intensities that they can while remaining clearly present in freeze-frame.

Where an image includes only a preceding or succeeding temporal shadow, the relative intensities of the strong image and the temporal shadow might typically be in the range 50:50 to 70:30. Where an image includes both preceding and succeeding temporal shadows, the relative intensities of the strong image and the two temporal shadows might typically be of the order of 60:20:20.

The relative intensities are important for the final result. Optimally, they should be subjectively determined in each case; e.g. because each filmed stage set and camera set-up is different. The look, the contrast, the brightness, the colour levels etc., will vary between different original motion picture sequences and require manipulation of all of the key variables, so that the processed images are satisfactory in normal playback and when viewed in freeze-frame.

Accordingly, the stated intensity ratios are a guide to values that will produce effective 3D enhancement most of the time. They could be used as the basis for default values in an automated or semi-automated process, with or without subsequent manual adjustment based on subjective appraisal of the images in normal playback and freeze-frame.

Each of the exemplary optical subcarrier cycle types will now be described in turn. These examples all relate to a cycles for producing “single channel” 3D-enhanced 2D motion picture sequences, where a single channel of images is to be presented to both eyes.

In each case, the processed sequence comprises a series of new fields NF1-NFn in which the strong image content corresponds to the content of the series of original fields OF1-OFn comprising the original sequence. The processing of the original sequence adds temporal shadow content to at least some of the original fields. The temporal shadow content is derived from at least one preceding original field and/or at least one succeeding original field. In these examples, the temporal shadow content for a new filed NFx is derived from one immediately preceding original field OFx−1 and/or one immediately succeeding original field OFx+1. The temporal shadow content of the new fields varies in a cyclical manner over a certain number of fields. Generally, this cyclical variation comprises cycles in which the new field content varies by including temporal shadow content from a preceding original field, temporal shadow content from a succeeding original field, temporal shadow content from both a preceding original field and a succeeding original field, or no temporal shadow content. Cyclical variations may also include variations in the relative intensities of the strong image and temporal shadow content of the fields. Otherwise similar cycle types may be distinguished only by differing cyclical intensity variations.

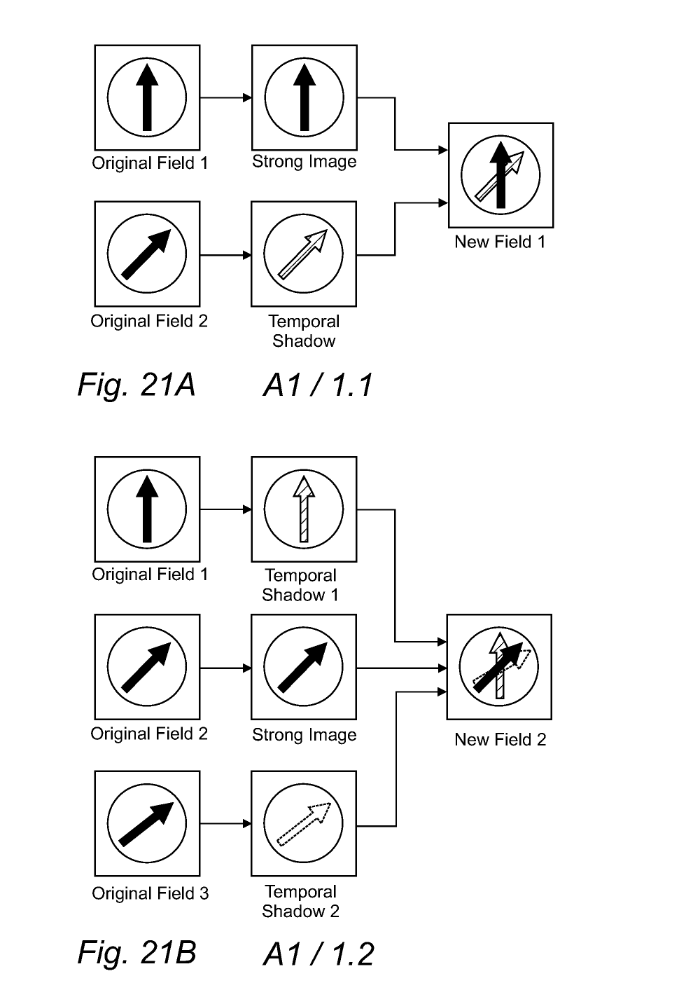

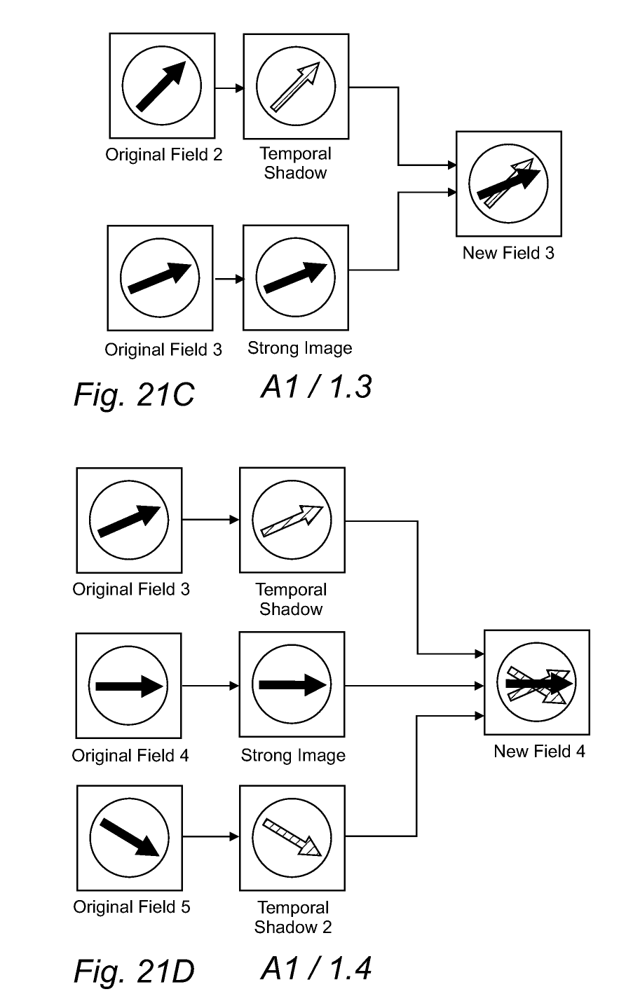

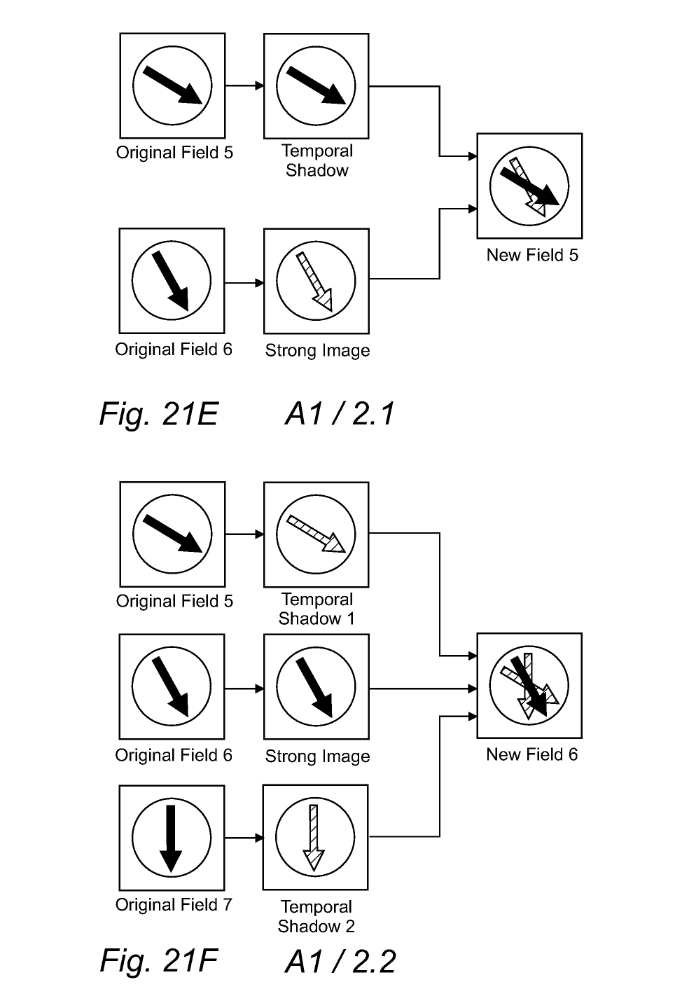

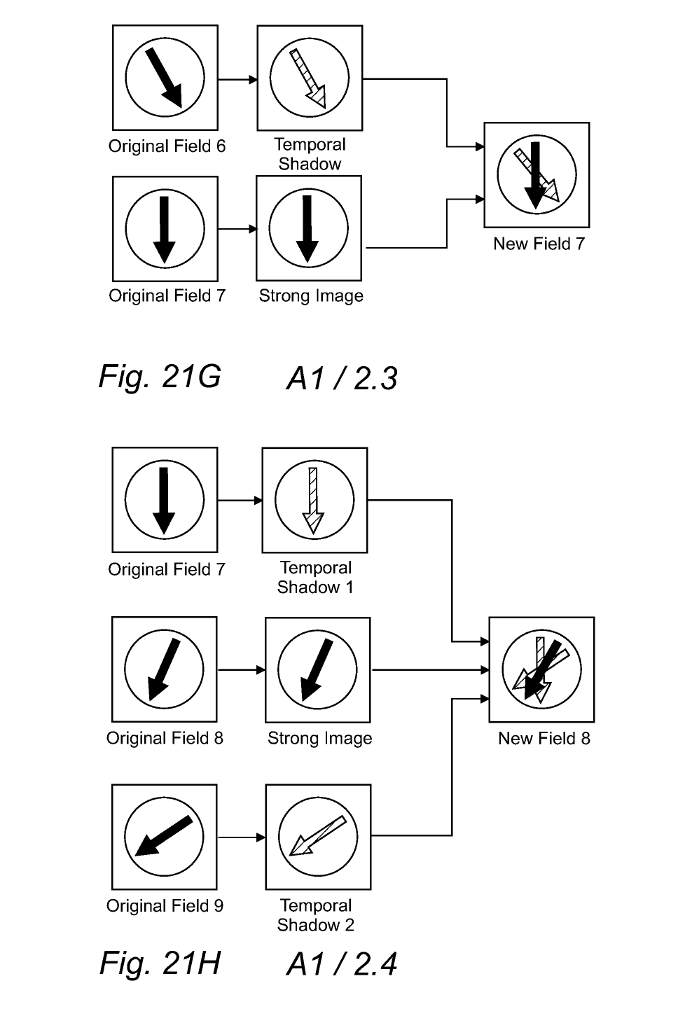

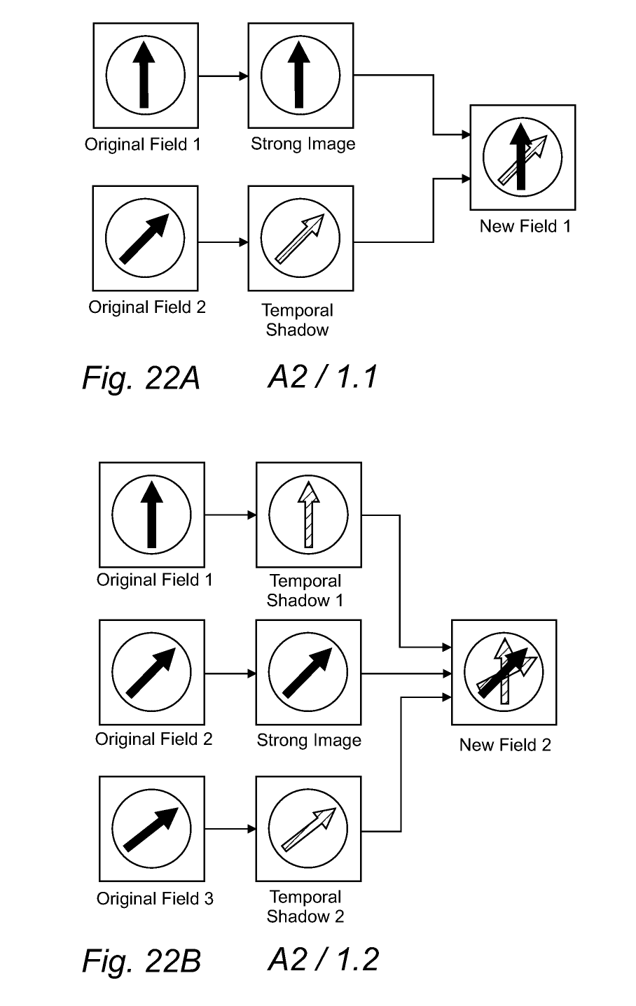

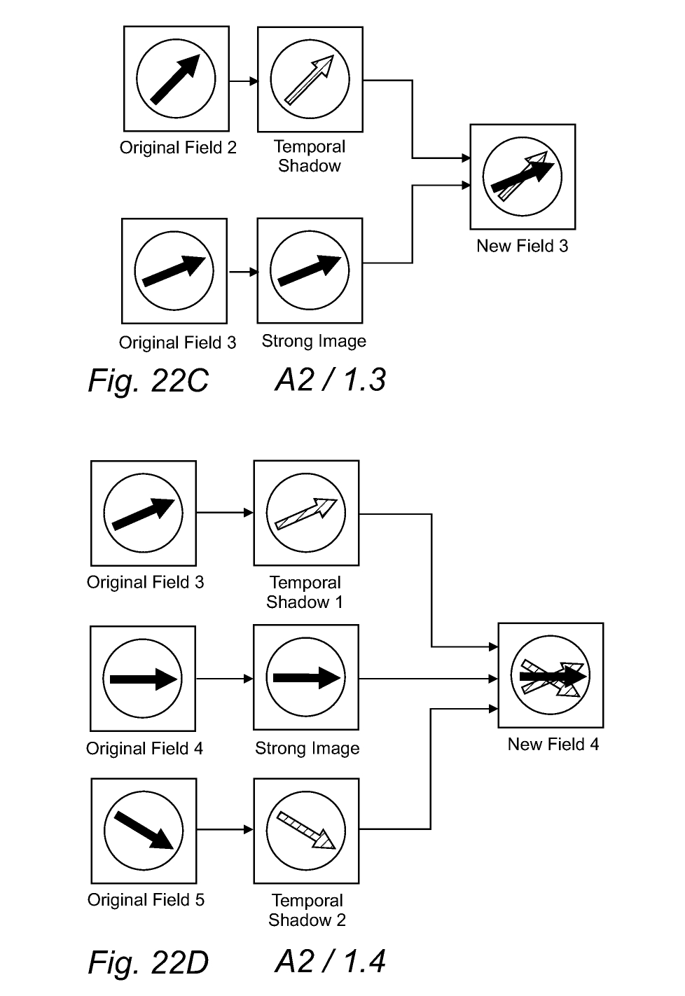

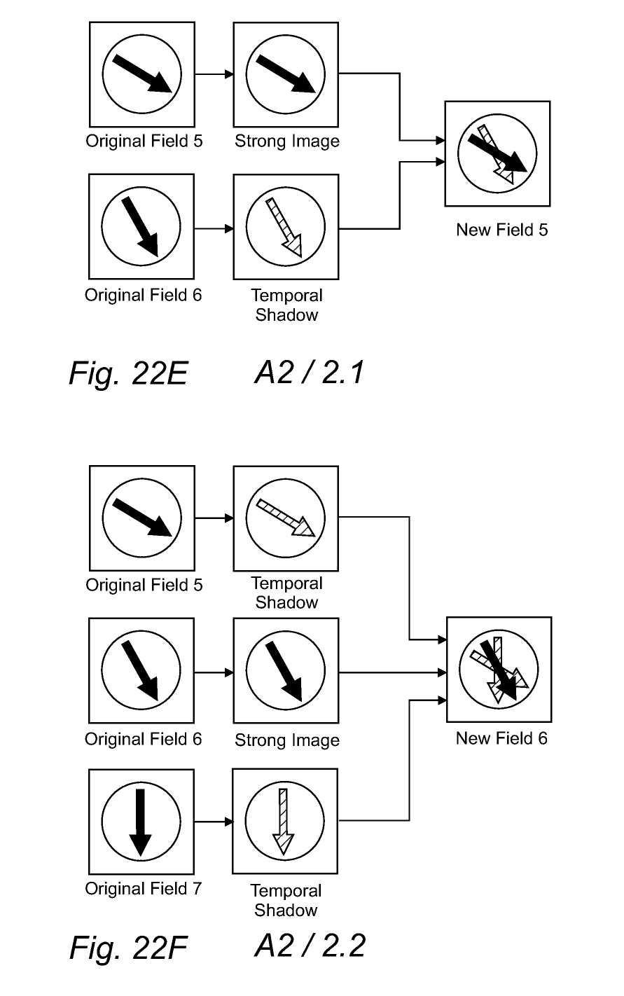

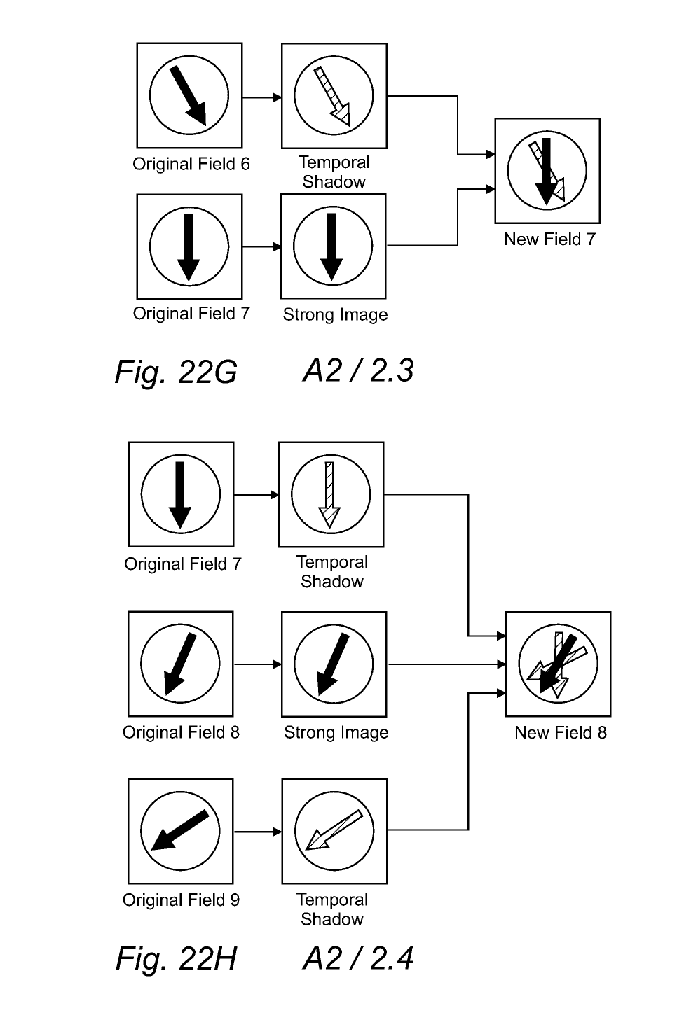

The various cycle types of the preferred embodiment are illustrated respectively in FIGS. 21, 22 and 27 to 33.

### Cycle A1 FIGS. 21A-21H

This cycle begins with an image that is produced from two original fields (see FIG. 21A, taken by the clock camera of FIG. 18). The two original fields—OF1 and OF2—produce respectively the strong image and the temporal shadow.

Each original field (OF1, OF2, OF3, OF4 . . . OFn) has a corresponding field in the processed sequence, referred to as the new fields (NF1, NF2, NF3, NF4 . . . NFn). The new fields are more complex images than their original field counterparts.

Two complete cycles of four field cycle A1 (cycle A1/1, fields A1/1.1 to A1/1.4 and cycle A1/2, fields A1/2.1 to A1/2.4) will be described by way of illustration.

### Cycle A1/1

### Field A1/1.1.

New field NF1, (see FIG. 21A) is produced from a combination of two original fields: OF1 and OF2. The original field OF1 produces the strong image. The original field OF2 produces the temporal shadow. The two ‘transformed fields’ are then blended together to produce new field NF1.

The strong image and the temporal shadow are present in equal intensity in the new field.

### Field A1/1.2.

New field NF2, (see FIG. 21B) is produced from a combination of three original fields OF1, OF2 and OF3. The original field OF2 produces the strong image. The original fields OF1 and OF3 produce the two temporal shadows. The three ‘transformed fields’ are then blended together to produce new field NF2.

The strong image and the temporal shadows are not present in equal intensity in the new field; this time the strong image has 60% of the intensity, with the temporal shadow produced by the original field OF1 having 23% of the intensity, and the temporal shadow produced by the original field OF3, having 17% of the intensity. The intensity ratio may also be 3:1:1; i.e. 60% strong image and 20% each for the two temporal shadows.)

The characteristics of fields A1-1.1 and A1-1.2 may be tabulated as follows:

| | | Shadow | Strong | Shadow | Inten- |
|---|---|---|---|---|---|
| A1 | NF# | Preceding OF# | Current OF# | Succeeding OF# | sity |
| 1.1 | 1 | | 1 | 2 | Equal |
| 1.2 | 2 | 1 | 2 | 3 | 23:60:17 |

This tabular format can be used to illustrate two complete cycles of cycle A1:

| | | Shadow | Strong | Shadow | Inten- |
|---|---|---|---|---|---|
| A1 | NF# | Preceding OF# | Current OF# | Succeeding OF# | sity |
| 1.1 | 1 | | 1 | 2 | Equal |
| 1.2 | 2 | 1 | 2 | 3 | 23:60:17 |
| 1.3 | 3 | 2 | 3 | | Equal |
| 1.4 | 4 | 3 | 4 | 5 | 23:60:17 |
| 2.1 | 5 | | 5 | 6 | Equal |
| 2.2 | 6 | 5 | 6 | 7 | 23:60:17 |
| 2.3 | 7 | 6 | 7 | | Equal |
| 2.4 | 8 | 7 | 8 | 9 | 23:60:17 |

(23:60:17 may be 20:60:20 throughout cycle type A1).

The same format will be used for each of the other cycle types.

### Cycle A2 FIGS.

Two complete cycles of four field cycle A2 (cycle A2/1, fields A2/1.1 to A2/1.4 and cycle A2/2, fields A2/2.1 to A2/2.4), are as follow:

| | | Shadow | Strong | Shadow | Inten- |
|---|---|---|---|---|---|
| A2 | NF# | Preceding OF# | Current OF# | Succeeding OF# | sity |
| 1.1 | 1 | | 1 | 2 | 65:35 |
| 1.2 | 2 | 1 | 2 | 3 | 23:60:17 |
| 1.3 | 3 | 2 | 3 | | 35:65 |
| 1.4 | 4 | 3 | 4 | 5 | 23:60:17 |
| 2.1 | 5 | | 5 | 6 | 65:35 |
| 2.2 | 6 | 5 | 6 | 7 | 23:60:17 |
| 2.3 | 7 | 6 | 7 | | 35:65 |
| 2.4 | 8 | 7 | 8 | 9 | 23:60:17 |

(23:60:17 may be 20:60:20 throughout cycle type A2).

It can be seen from the foregoing tables and the accompanying drawings that the basic combinations of the strong images from the “current” original fields and the temporal shadows from the preceding and succeeding original fields are the same for both cycle types A1 and A2. The new fields (in these examples, the even numbered new fields) that combine the current original field with temporal shadows from both the preceding and succeeding original fields are identical in both cases. The two types are also similar in that the single temporal shadow that is included in the odd numbered new fields alternates between being derived from the succeeding original field and the preceding original field. The difference between the two cycle types is the relative intensities of the strong image and the single temporal shadow in the odd numbered new fields: in A1 they are combined with equal intensity and in A2 they are combined with the strong image having an intensity of 65% and the temporal shadow having an intensity of 35%.

In summary, then, cycle types A1 and A2 are both four field cycles in which first processed fields including temporal shadow content derived from both preceding and succeeding original fields alternate with second processed fields including temporal shadow content from either a preceding original field or a succeeding original field, the temporal shadow content of the second processed fields alternating between preceding and succeeding original fields. In the first processed fields, the relative intensities of the temporal shadow content from the preceding original field, the strong image content from the current original field and the temporal shadow content from the succeeding original field are in the ratio 23:60:17 or 20:60:20. In the second processed fields, the relative intensities of the temporal shadow content from the preceding or succeeding original field and the strong image content from the current original field are in the ratio 50:50 for cycle type A1 or 35:65 for cycle type A2.

Following the sequence of images in these two cycle types, cycle A1 and cycle A2, additional cycles and their patterns can be seen within the five field cycle.

In each field, the viewer is being presented with a strong image of an object and one or two further different perspectives (the temporal shadows, usually just to the left and/or just to the right, but also sometimes just above and/or just below) of that same object. These additional perspectives vary at high frequency (the field rate of the sequence) and in a cyclical manner, and give the object a more rounded, more physical presence in the brain's understanding of the image, as the viewer is receiving more and slightly varied orientations of the object.

As a result each object has a high frequency (suitably 50 Hz or 60 Hz) “oscillating edge” that subliminally calls the attention of the “deeper brain” to its overlapping of the objects behind it, as its edge momentarily encroaches upon and then recedes from the position and image of the object and objects behind it.

Consequently, this “oscillating edge” gives each object the aforementioned bi-directional occlusion, and because the appearance of these temporal shadows is happening at a high frequency (50 times a second for PAL video; 60 times a second for NTSC video) they are not seen at a conscious level, unless the sequences are paused in freeze-frame mode.

As a result of the high frequency of their appearance and their construction of the “oscillating edge” around many of the objects in the image, the temporal shadows have a subliminal quality, and therefore although they are not fully detected consciously they do reinforce, at a subconscious and deeper cognitive level, the brain's sense that objects are physically in front of other objects.

The subliminally oscillating edges that are introduced through the optical subcarrier cycles give the viewer very powerful cues that objects are in different planes, because there are now additional cues to indicate that they are in front of, or behind, other objects. Together these changes make it almost impossible to now see the image as a flat image. It is notable that this is the case even when the motion picture sequence is viewed through one eye only.

It is also the case that by varying the relative intensity of the temporal shadows and the strong images, the edge of each object now has a less fixed, and therefore less artificial presence in the image, it is as though the edge of each object is now more ‘alive’.

These edge variations, both through occlusion and also through intensity changes, occur at a frequency that pushes them beyond clear, conscious detection, but they are detected subliminally and they result in an image that has much more information in it. There is now a much greater rate of change in the image, and this also creates a sensation of a greater “physical personal interface” with the displayed image which aids the sensation of greater depth. Importantly, alternating the different orientations of the temporal shadows allows the brain to see the images at a deeper cognitive level, where they are fully detected and comprehended as different cognitive events, which makes it easier for the brain to interpret the initial input, as having arrived through different eyes.

The present optical subcarrier cycles may be further represented graphically as follows.

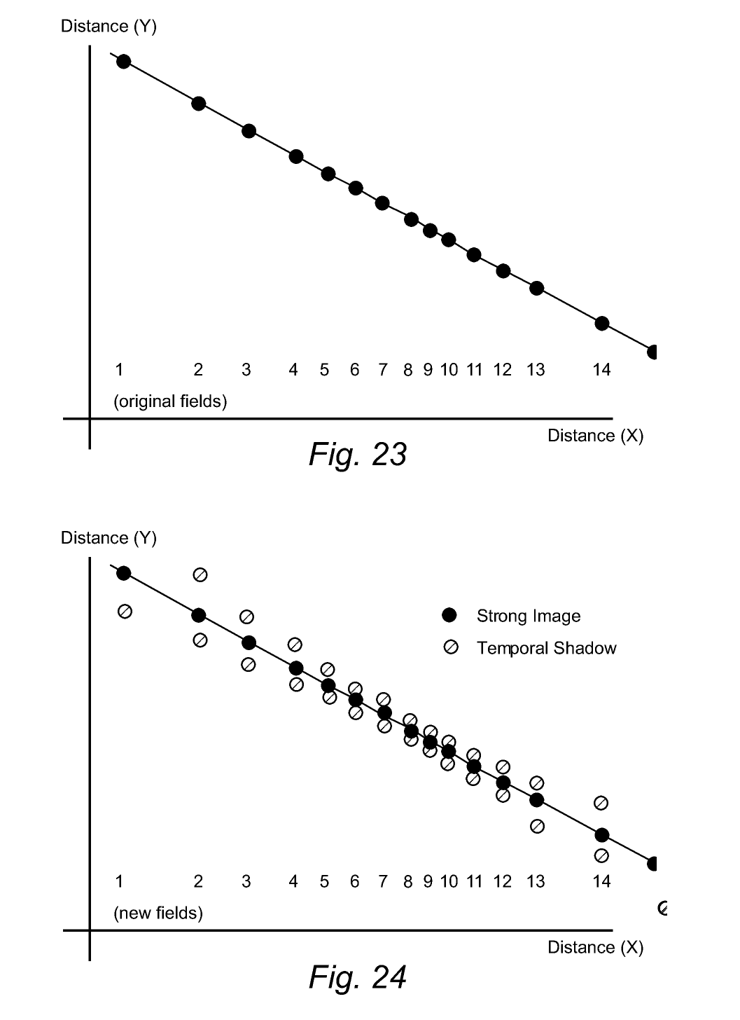

Consider firstly an object travelling in a straight line, but decelerating, before accelerating again. The motion of such an object, can be represented on a grid with X and Y axes for distance traveled, as shown in FIG. 23, which is a standard graphical representation of an object undergoing such velocity changes. This graphical representation also equates to the position that the object would occupy in a film frame, were a stationary camera filming its movement during the same period. The entire sequence of movements is as would be the result of superimposing all of the filmed frames, one on top of the other.

Consider now how such a graphical representation would look if it also included two temporal shadows, one from the preceding frame and one from the succeeding frame: see FIG. 24. The positional relationships between the temporal shadows and the main object can clearly be seen, and also the way in which these relationships vary with time. In particular, it can be seen how the distances between the temporal shadows and the main object in each frame varies according to the speed at which the main object is travelling. FIG. 24 does not actually represent one of the present cycles, but serves to indicate the manner in which the relationships may be represented graphically.

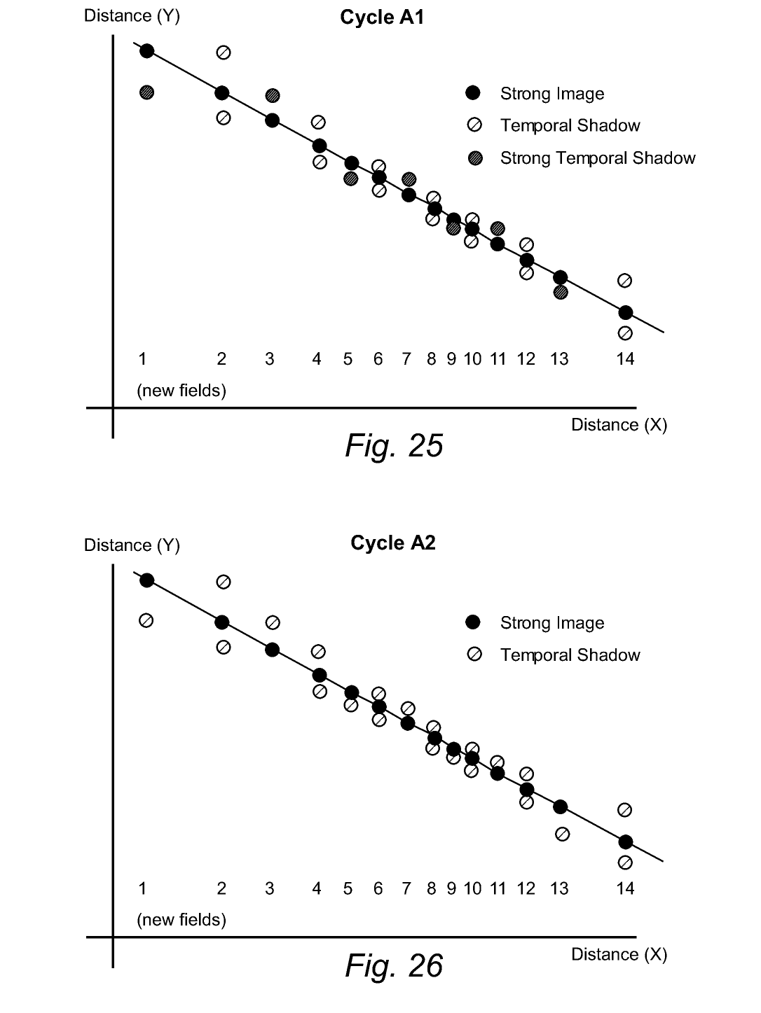

Cycle A1 is represented in the same way in FIG. 25, and cycle A2 in FIG. 26.

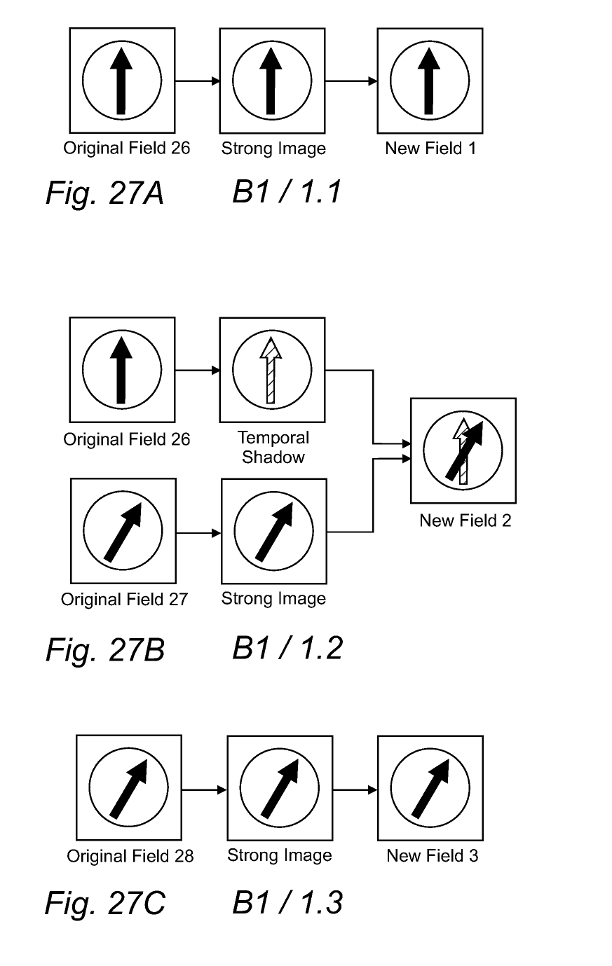

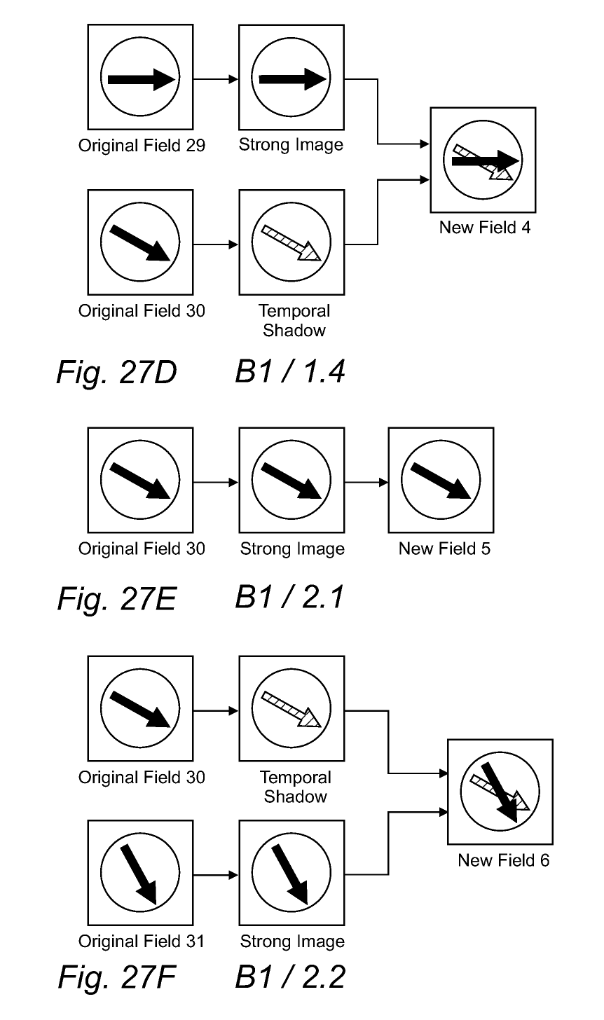

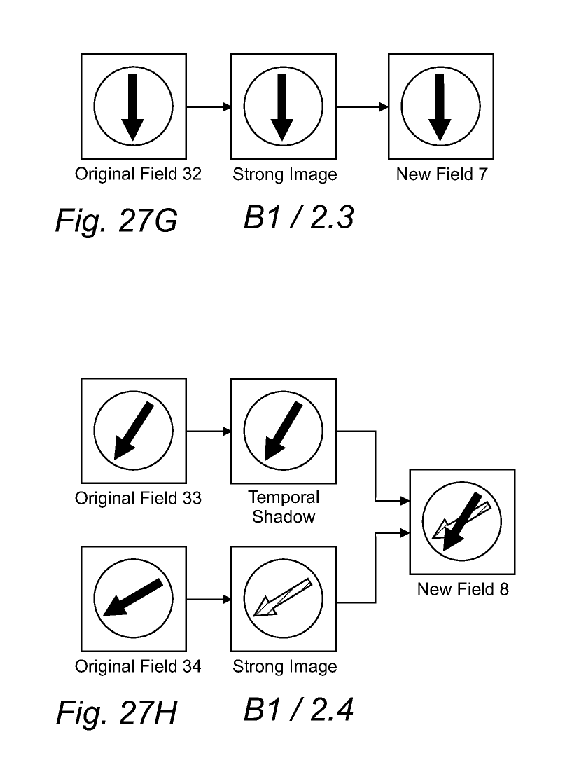

### Cycle B1 FIGS. 27A to 27H

Two complete cycles of four field cycle B1 (cycle B1/1, fields B1/1.1 to B1/1.4 and cycle B112, fields B1/2.1 to B1/2.4), are as follow:

(This two cycle example begins after one half second (25 fields) has elapsed, so that processing begins at OF26.)

| | | Shadow | Strong | Shadow | Inten- |
|---|---|---|---|---|---|
| B1 | NF# | Preceding OF# | Current OF# | Succeeding OF# | sity |
| 1.1 | 1 | | 26 | | |
| 1.2 | 2 | 26 | 27 | | 35:65 |
| 1.3 | 3 | | 28 | | |
| 1.4 | 4 | | 29 | 30 | 65:35 |
| 2.1 | 5 | | 30 | | |
| 2.2 | 6 | 30 | 31 | | 35:65 |
| 2.3 | 7 | | 32 | | |
| 2.4 | 8 | | 33 | 34 | 65:35 |

Note that the intensity of the strong image in even fields (with shadow) is less than the intensity of the strong image in odd fields (no shadow), but each field has the same overall intensity and all other general parameters are unchanged

In summary, then, cycle type B1 is a four field cycle in which first processed fields including only strong image content corresponding to the current original field alternate with second processed fields including strong image content corresponding to the current original field and temporal shadow content from either a preceding original field or a succeeding original field, the temporal shadow content of the second processed fields alternating between preceding and succeeding original fields. In the second processed fields, the relative intensities of the temporal shadow content from the preceding or succeeding original field and the strong image content from the current original field are in the ratio 35:65. That is, cycle type B1 is similar to cycle type A2, except that the “first” processed fields in B1 include only strong image content whereas the “first” processed fields in A2 include temporal shadow content from both preceding and succeeding fields.

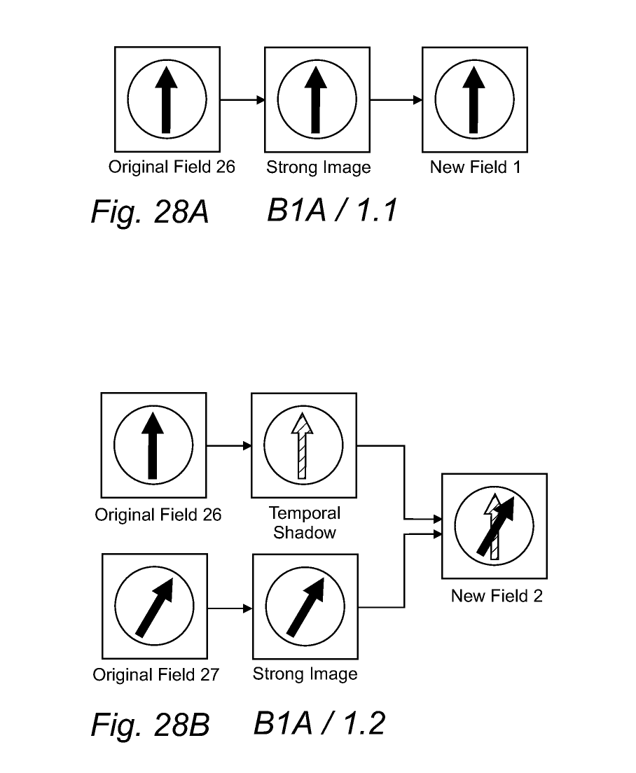

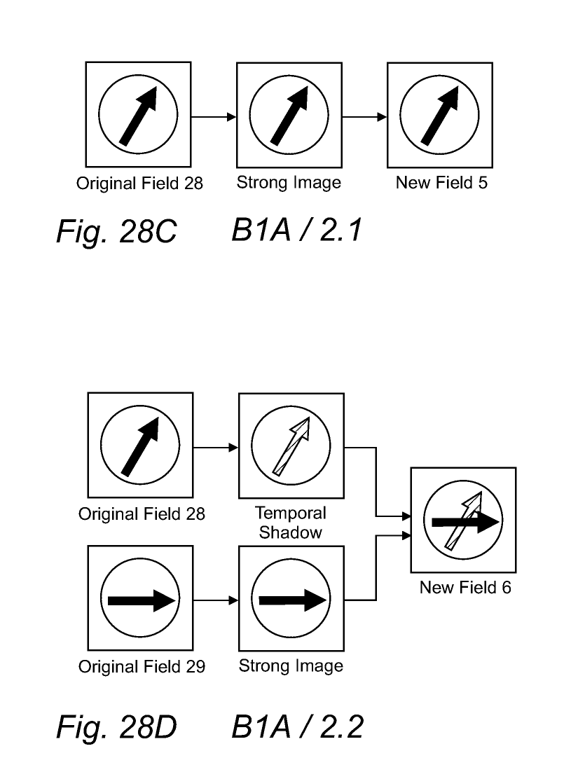

### Cycle 131A FIGS. 28A to 28D

Two complete cycles of two field cycle B1A (cycle B1A/1, fields B1A/1.1 and B1A/1.2 and cycle B1A/2, fields B1A/2.1 and B1A/2.2), are as follow: This two cycle example begins after one half second (25 fields) has elapsed, so that processing begins at OF26. This is simply indicative of the fact that any particular cycle type can be applied to any series of images within a longer sequence, supplanting a different cycle type that has been applied to a preceding series of images.

| | | Shadow | Strong | Shadow | Inten- |
|---|---|---|---|---|---|
| B1A | NF# | Preceding OF# | Current OF# | Succeeding OF# | sity |
| 1.1 | 1 | | 26 | | |
| 1.2 | 2 | 26 | 27 | | Equal |
| 2.1 | 3 | | 28 | | |
| 2.2 | 4 | 28 | 29 | | Equal |

Note that the intensity of the strong image in even fields (with shadow) is less than the intensity of the strong image in odd fields (no shadow), but each field has the same overall intensity and all other general parameters are unchanged

In summary, then, cycle type B1A is a two field cycle in which first processed fields including only strong image content corresponding to the current original field alternate with second processed fields including strong image content corresponding to the current original field and temporal shadow content from preceding original field. In the second processed fields, the relative intensities of the temporal shadow content from the preceding field and the strong image content from the current original field are in the ratio 50:50.

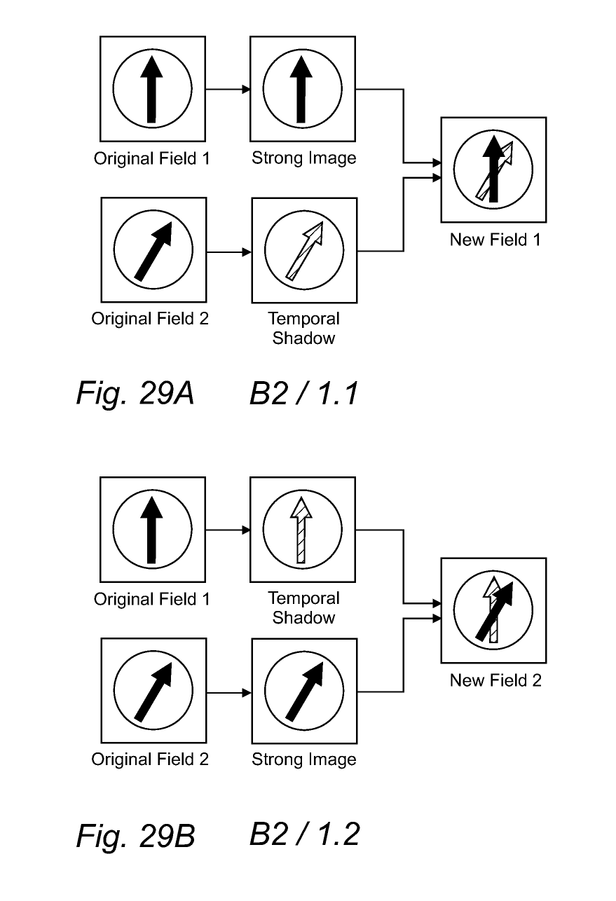

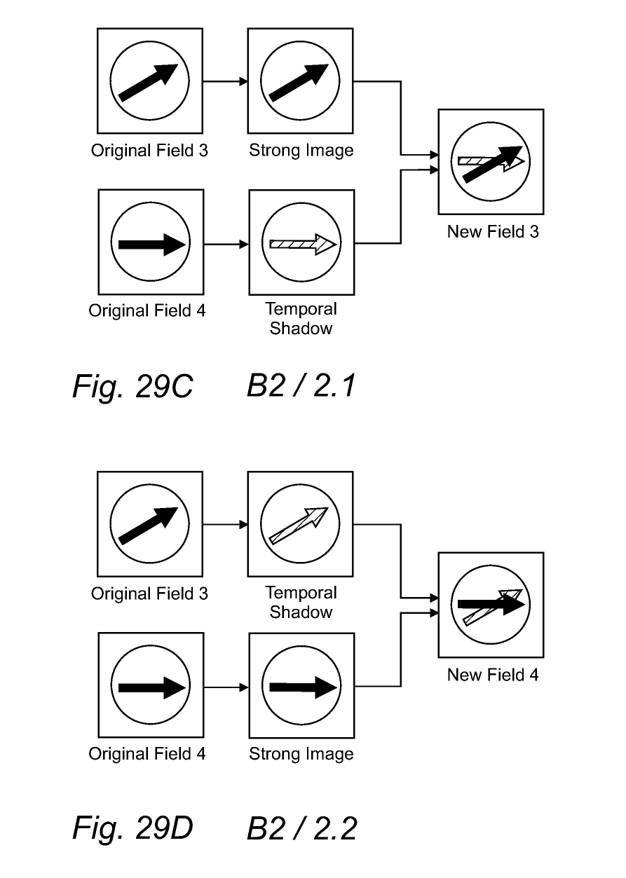

### Cycle B2 FIGS. 29A to 29D

Two complete cycles of two field cycle B2 (cycle B2/1, fields B211.1 to B2/1.2 and cycle B2/2, fields B2/2.1 to B2/2.2), are as follow:

| | | Shadow | Strong | Shadow | Inten- |
|---|---|---|---|---|---|
| B2 | NF# | Preceding OF# | Current OF# | Succeeding OF# | sity |
| 1.1 | 1 | | 1 | 2 | 65:35 |
| 1.2 | 2 | 1 | 2 | | 35:65 |
| 2.1 | 3 | | 3 | 4 | 65:35 |
| 2.2 | 4 | 3 | 4 | | 35:65 |

In summary, then, cycle type B2 is a two field cycle in which first processed fields including strong image content corresponding to the current original field and temporal shadow content from a succeeding original field alternate with second processed fields including strong image content corresponding to the current original field and temporal shadow content from a preceding original field. In all processed fields, the relative intensities of the temporal shadow content from the preceding field and the strong image content from the current original field are in the ratio 35:65.

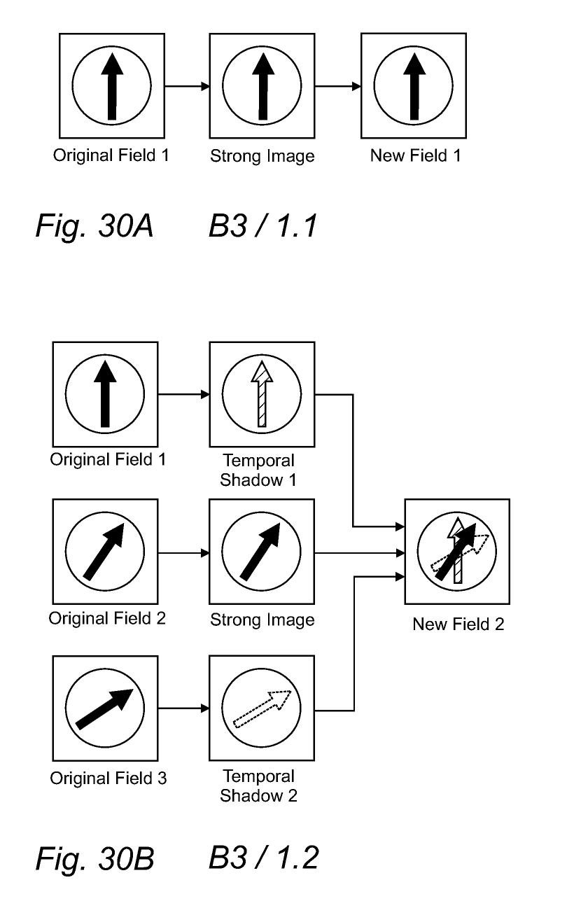

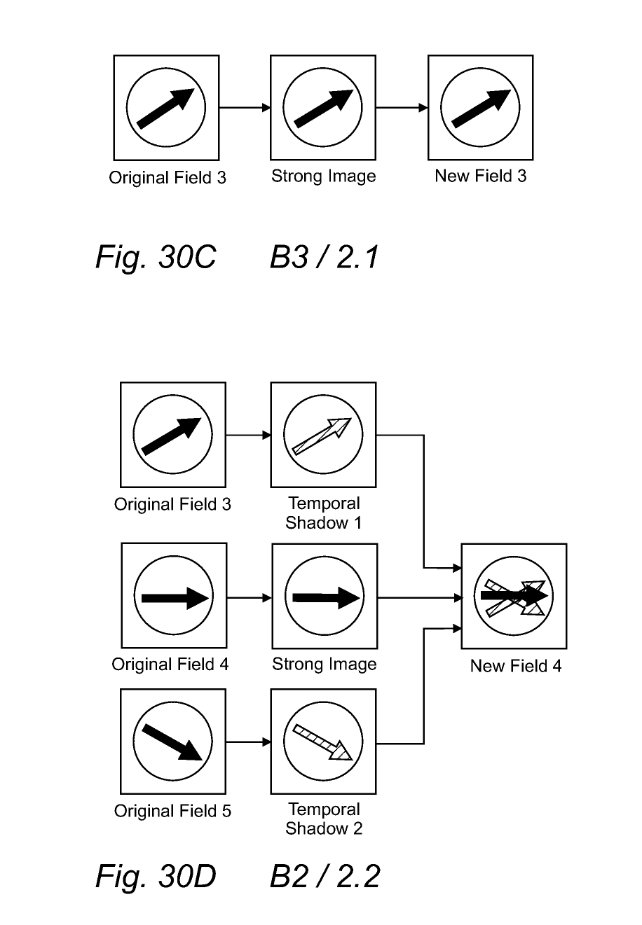

### Cycle B3 FIGS. 30A to 30D

Two complete cycles of two field cycle B3 (cycle B3/1, fields B3/1.1 to B3/1.2 and cycle B3/2, fields B3/2.1 to B3/2.2), are as follow:

| | | Shadow | Strong | Shadow | Inten- |
|---|---|---|---|---|---|
| B3 | NF# | Preceding OF# | Current OF# | Succeeding OF# | sity |
| 1.1 | 1 | | 1 | | |
| 1.2 | 2 | 1 | 2 | 3 | 23:60:17 |
| 2.1 | 3 | | 3 | | |
| 2.2 | 4 | 3 | 4 | 5 | 23:60:17 |

(23:60:17 may be 20:60:20 throughout cycle type B3).

Note that the intensity of the strong image in even fields (with shadows) is less than the intensity of the strong image in odd fields (no shadows), but each field has the same overall intensity and all other general parameters are unchanged.

In summary, then, cycle type B3 is a two field cycle in which first processed fields including only strong image content corresponding to the current original field alternate with second processed fields including strong image content corresponding to the current original field and temporal shadow content from both preceding and succeeding original fields. In the second processed fields, the relative intensities of the temporal shadow content from the preceding original field, the strong image content from the current original field and the temporal shadow content from the succeeding original field are in the ratio 23:60:17 or 20:60:20.

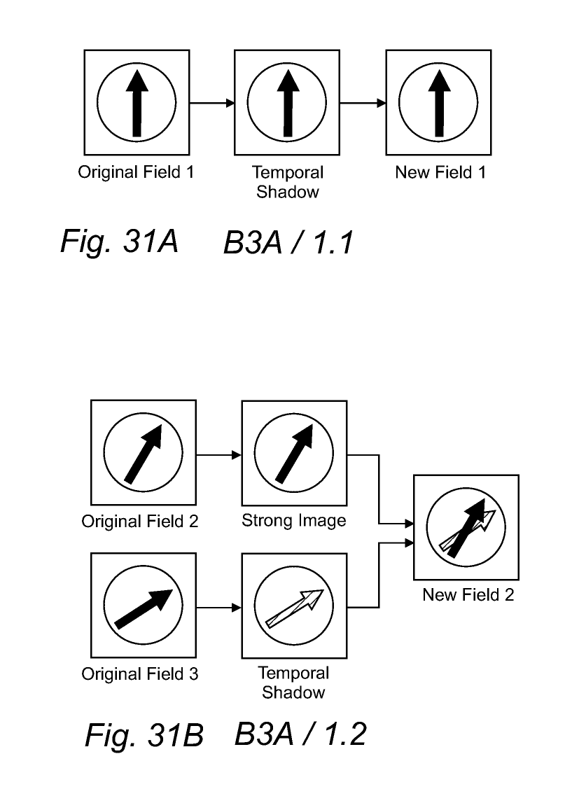

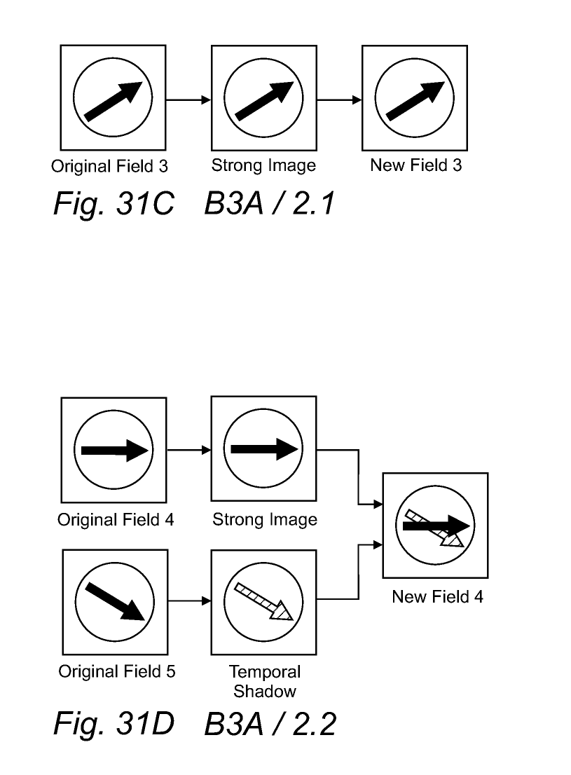

### Cycle B3A FIGS. 31A to 31D

Two complete cycles of two field cycle B3A (cycle B3A/1, fields B3A/1.1 and B3A/1.2 and cycle B3A/2, fields B3A/2.1 and B3A/2.2), are as follow:

| | | Shadow | Strong | Shadow | Inten- |
|---|---|---|---|---|---|
| B3A | NF# | Preceding OF# | Current OF# | Succeeding OF# | sity |
| 1.1 | 1 | | 1 | | |
| 1.2 | 2 | | 2 | 3 | Equal |
| 2.1 | 3 | | 3 | | |
| 2.2 | 4 | | 4 | 5 | Equal |

Note that the intensity of the strong image in even fields (with shadows) is less than the intensity of the strong image in odd fields (no shadows), but each field has the same overall intensity and all other general parameters are unchanged.

In summary, then, cycle type B3A is a two field cycle in which first processed fields including only strong image content corresponding to the current original field alternate with second processed fields including strong image content corresponding to the current original field and temporal shadow content from a succeeding original field. In the second processed fields, the relative intensities of the temporal shadow content from the preceding field and the strong image content from the current original field are in the ratio 50:50.

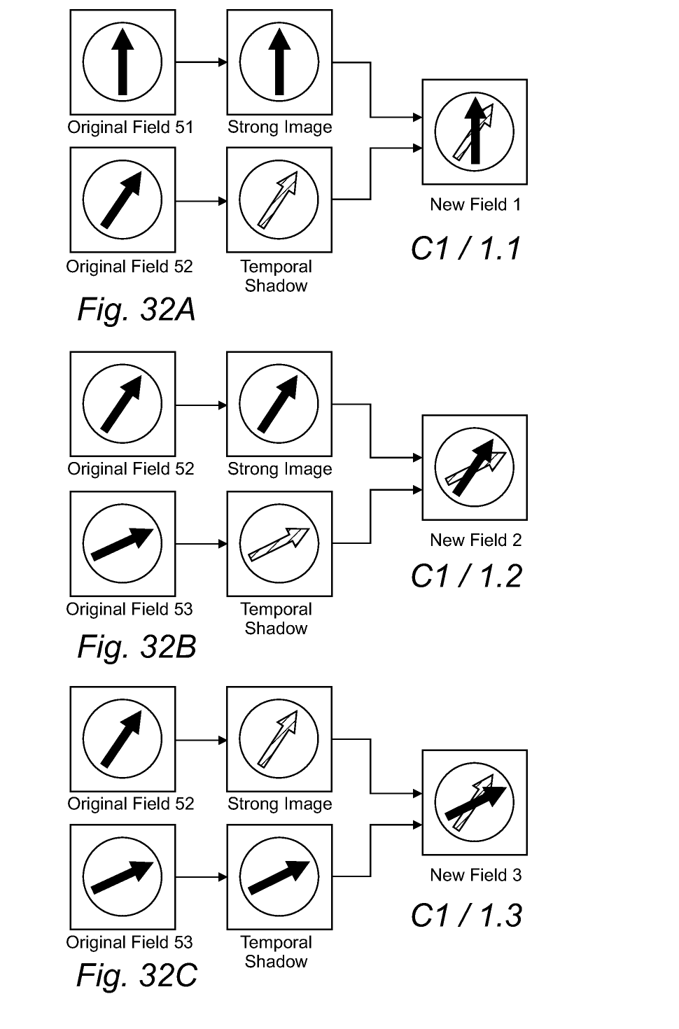

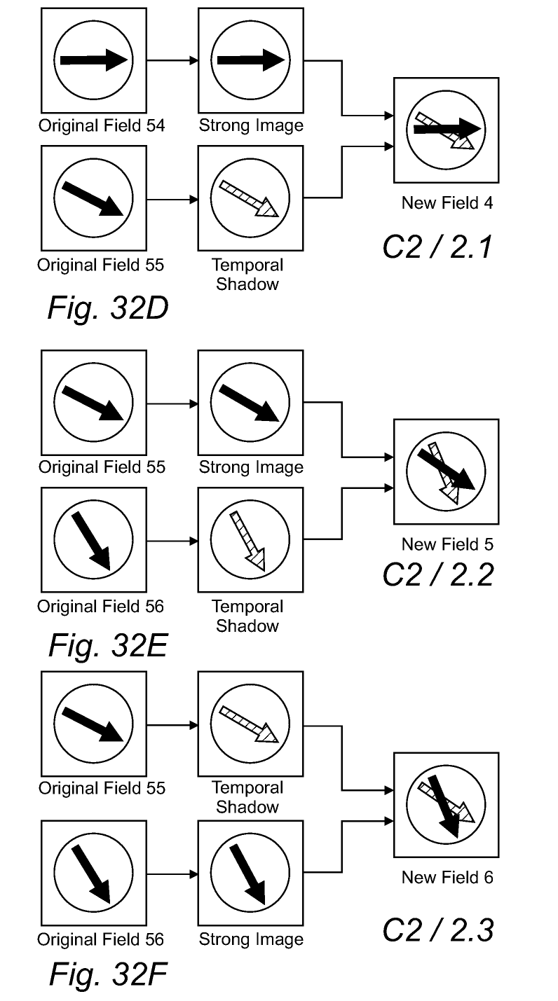

### Cycle C FIGS. 32A to 32E

Two complete cycles of three field cycle C (cycle C/1, fields C/1.1 to C/1.3 and cycle C/2, fields C/2.1 to C/2.3), are as follow:

(This two cycle example begins after one second (50 fields) has elapsed, so that processing begins at OF51.)

| | | Shadow | Strong | Shadow | Inten- |
|---|---|---|---|---|---|
| C | NF# | Preceding OF# | Current OF# | Succeeding OF# | sity |
| 1.1 | 1 | | 51 | 52 | Equal |
| 1.2 | 2 | | 52 | 53 | 70:30 |
| 1.3 | 3 | 52 | 53 | | 30:70 |
| 2.1 | 4 | | 54 | 55 | Equal |
| 2.2 | 5 | | 55 | 56 | 70:30 |
| 2.3 | 6 | 55 | 56 | | 30:70 |

In summary, then, cycle type C is a three field cycle in which first and second successive processed fields include strong image content corresponding to the current original field and temporal shadow content from a succeeding original field, and the third successive processed field includes strong image content corresponding to the current original field and temporal shadow content from a preceding original field. In the first processed field, the relative intensities of the temporal shadow content from the succeeding field and the strong image content from the current original field are in the ratio 50:50. In the second processed field, the relative intensities of the temporal shadow content from the succeeding field and the strong image content from the current original field are in the ratio 30:70. In the third processed field, the relative intensities of the temporal shadow content from the preceding field and the strong image content from the current original field are in the ratio 30:70.

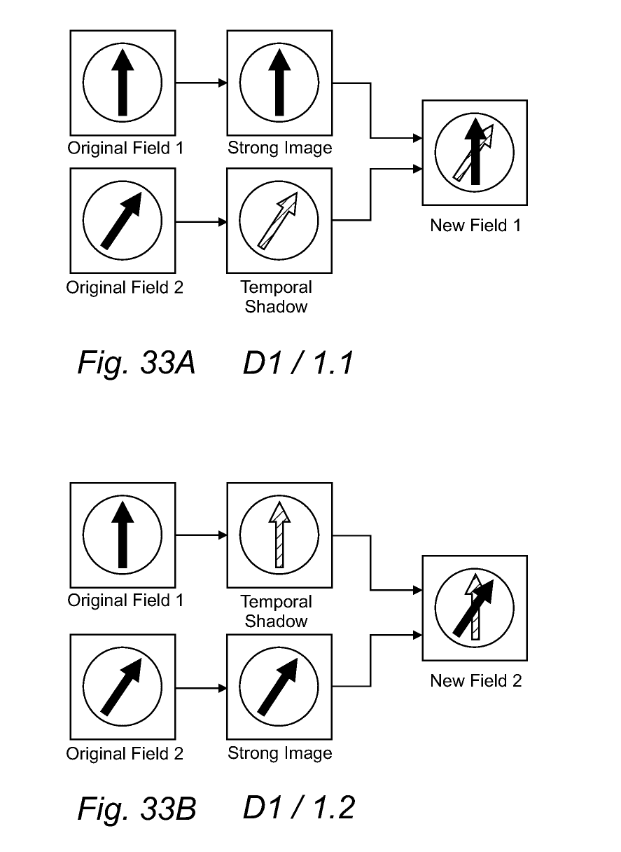

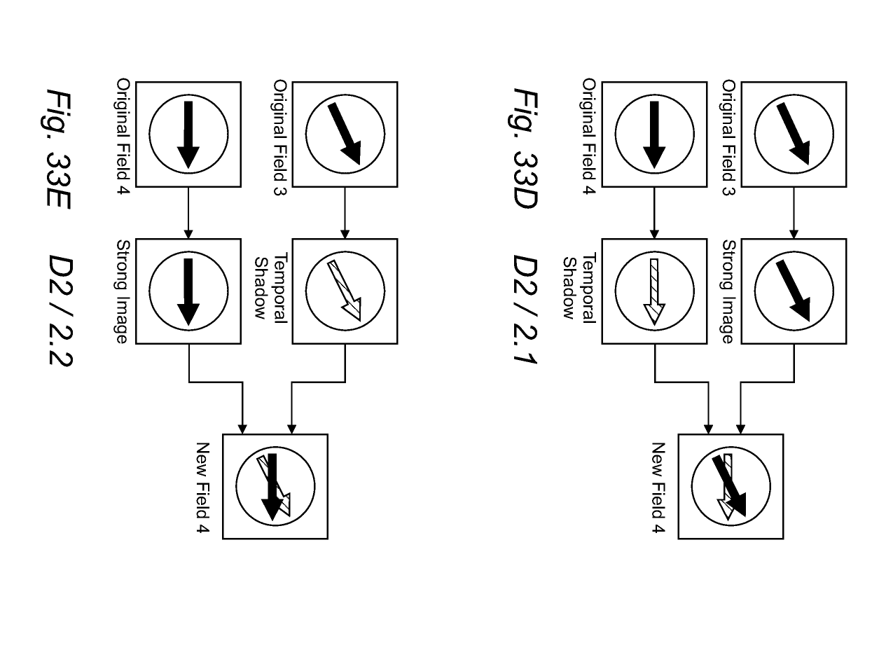

### Cycle D FIGS. 33A to 33D

Two complete cycles of two field cycle D (cycle D/1, fields D/1.1 and D/1.2 and cycle D/2, fields D/2.1 and D/2.2), are as follow:

| | | Shadow | Strong | Shadow | Inten- |
|---|---|---|---|---|---|
| D | NF# | Preceding OF# | Current OF# | Succeeding OF# | sity |
| 1.1 | 1 | | 1 | 2 | 70:30 |
| 1.2 | 2 | 1 | 2 | | 30:70 |
| 2.1 | 3 | | 3 | 4 | 70:30 |
| 2.2 | 4 | 3 | 4 | | 30:70 |

In summary, then, cycle type D is a two field cycle in which first processed fields including strong image content corresponding to the current original field and temporal shadow content from a succeeding original field alternate with second processed fields including strong image content corresponding to the current original field and temporal shadow content from a preceding original field. In all processed fields, the relative intensities of the temporal shadow content from the preceding field and the strong image content from the current original field are in the ratio 30:70. That is, cycle type D is similar to cycle type B2 apart from the relative intensities of the strong image content and the temporal shadow content.

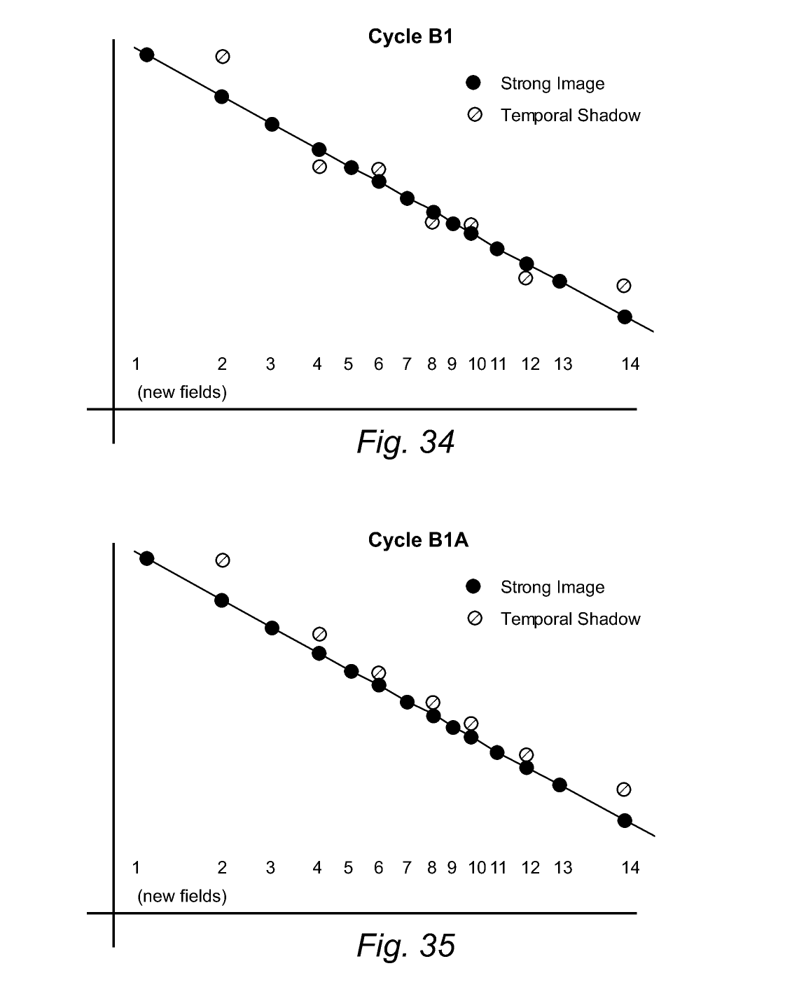

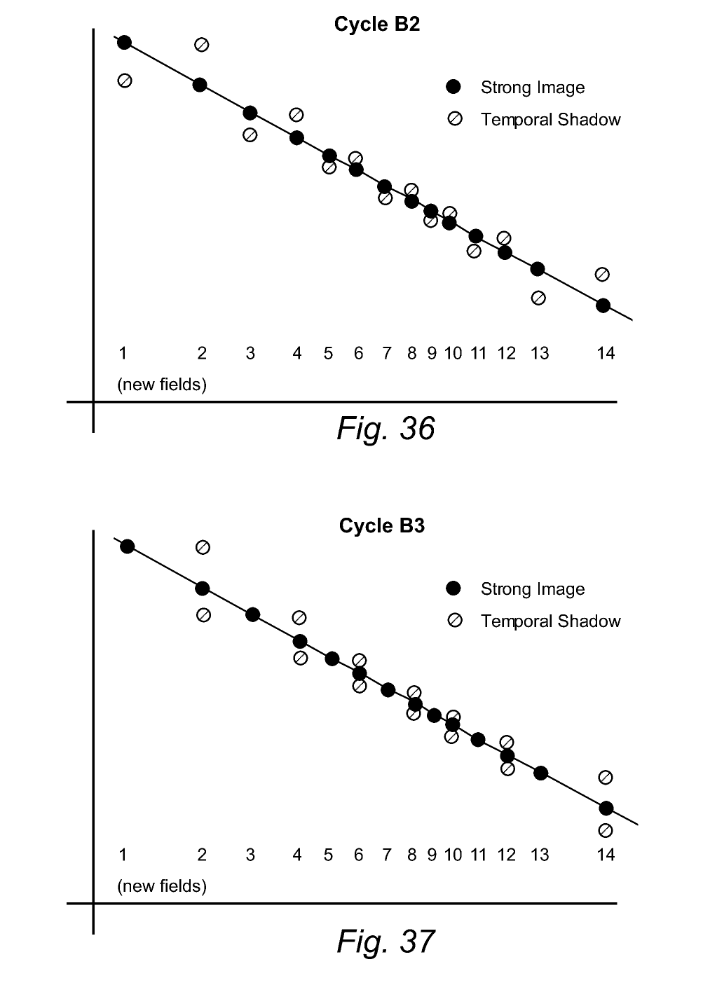

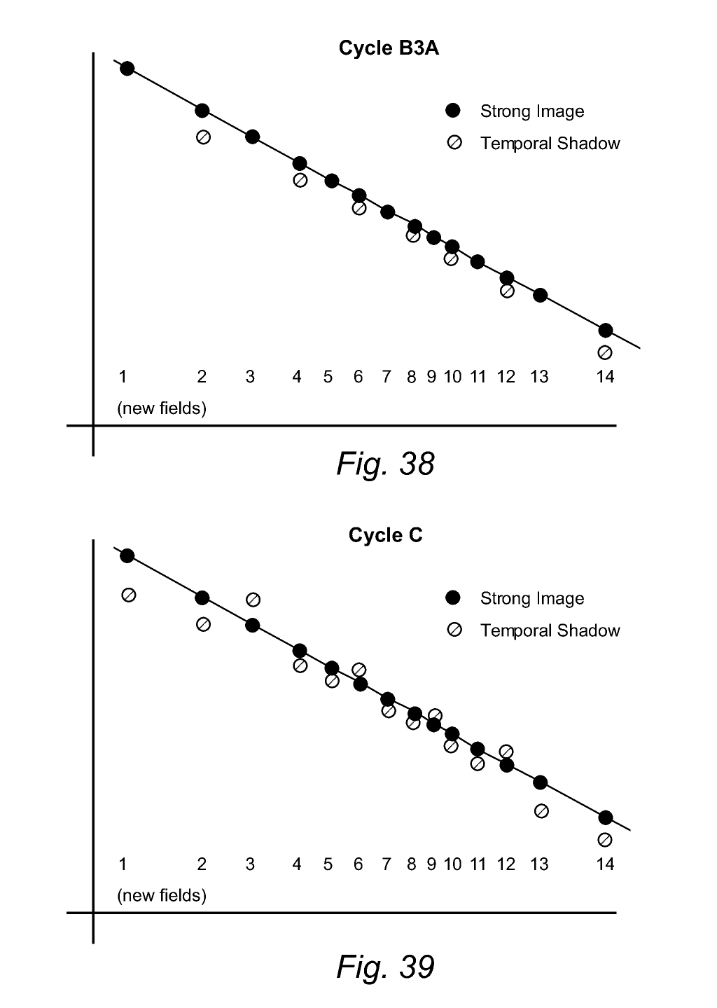

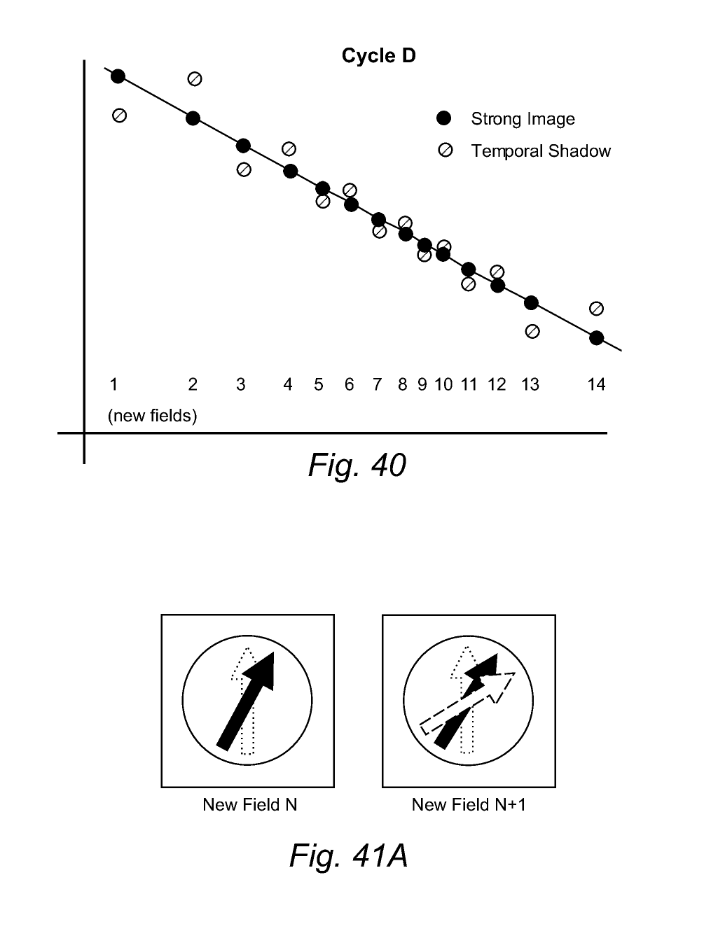

Using the same “standard” graphical representation of an object in motion as in FIGS. 23 and 24, cycle B1 is illustrated in FIG. 34, cycle B1A in FIG. 35, cycle B2 in FIG. 36, cycle B3 in FIG. 37, cycle B3A in FIG. 38, cycle C in FIG. 39, and cycle D in FIG. 40.

As previously stated, FIG. 24 does correspond to any of the present cycles, but represents a scenario in which each frame includes temporal shadows from their preceding and succeeding fields. The purpose of FIG. 24 is to illustrate, by comparison to FIG. 23, how the present cycles introduce into each frame one of the direct consequences of stereo vision: the perception of double images/double edges etc. The addition of the temporal shadows to the original field causes objects to be represented with more complex outlines, as opposed to the singular outline as seen in the monoscopic image of the original field.

FIG. 24 (and the other Figs. representing the actual cycles), even with this simplification, illustrates the more complex positional relationships that the optical complex of the present cycles introduce into each new processed motion picture sequence. There is now more information in each field.

The brain's interpretation of this increased information is such that, although it does de-resolve the image, it adds a very strong sense of reality, and of three-dimensional reality in particular. This increased depth reality more than offsets the slight loss of focus, adding to the mental clarity of the meaning of the scene.

Looking at FIGS. 34 to 40, it can be seen how the interplay between the strong images and the temporal shadows works to effectively create a subliminally multiplexed, high frequency “optical complex” of images that represent a more realistic stereo photographic view, such that this subliminal multiplex can then enter the brain from a single 2D display, through both eyes—or even one eye (with the other closed)—whereupon the brain then cognitively demultiplexes them, and allows the impression of a three dimensional image, to be built up and received.

Certain ones of the optical subcarrier cycles described above are of quite general application, and will result in meaningful 3D-enhancement in a wide variety of 2D motion picture sequences. Others find more specific application to motion picture sequences having more particular characteristics in terms of their content etc. In use, particular cycle types will be selected for application to particular sequences. The considerations applying to such selections will now be discussed.

Almost all 2D motion picture sequences contain a good deal of 3D information. The present optical subcarrier cycles are intended to ‘unlock’ this information, which is contained within the relative changes of the shapes of objects between successive frames and, perhaps even more importantly, within the relative changes of the distances between objects in successive frames.

The cycles, in effect, create two image sequences, that work through being registered separately by the viewer in normal viewing and then through being combined together in the occipital lobes of the viewer, to produce one understanding—an enhanced depth image.

The first image sequence is made up of the strong image—which all nine cycle types include in exactly the same way: this is the original 2D image sequence of the original, unmodified motion picture sequence—the image that is intended to be seen directly and that is seen consciously by the viewer.

All nine cycle types produce slightly different second image sequences—the temporal shadow images—and there is further variety in the degree of degradation and transparency of the temporal shadows, and in their relative intensity as compared with the strong image. This second image, produced differently by each cycle type, is the optical subcarrier. It is the image that is responsible for the viewer “understanding” the complete picture as an enhanced depth image, or even a 3D image.

The second image is not intended to be seen directly or consciously. It is intended to be subliminal and it is only clearly visible when the image is paused—at which point the strong image and the temporal shadow can both be seen together. In normal playback the second image—the optical subcarrier—cannot generally be seen, and certainly not seen clearly. It is registered fully, however, at the subconscious level, and it is seen by the processing sites within the occipital lobes.

That is, all of the cycle types create a first image sequence that is intended to be seen consciously, and simultaneously create a second image sequence that is subliminal, intended to be registered sub-consciously.

The main cycle types are A1 and A2. These two cycle types are very similar will create the two image sequences satisfactorily in about 80% of all cases.

The other cycle types are to be used when objects on the screen are moving faster than normal, and in unusual modes.

The reason for this is that when objects are moving too fast, the temporal shadow has a greater area, and the image footprint with the strong image is much greater. When this happens the optical subcarrier breaks across the subliminal threshold and becomes a consciously registered image. This causes the relationship between the strong image and the optical subcarrier, between the conscious and the unconscious images, to break down. When this happens the effect is reduced or lost.

If we look at the variations within each cycle type the key variables are:
granular quality and resolution of the image
transparency
relative intensity as compared to the strong image.

These qualities are varied according to the relative motions of the objects within the frame, and also according to the nature of the overall image—the brightness, the colour saturation and the contrast.

By adjusting these key variables, the optical subcarrier registers to a greater or lesser extent sub-consciously, but is intended to be kept just below the conscious detection threshold.

The most powerful effect is achieved by creating the most “present and detectable” image of the sub-carrier when the image is viewed in freeze-frame, but which as soon as the image sequence is allowed to run, then dips below the conscious threshold and cannot be clearly registered—except of course as the sensation of depth within the image.

The cycle types may be selected by viewing the images in these two modes:

[A] Freeze-frame mode: one still frame at a time (Viewing Mode A: VMA) and
[B] full normal playback. (Viewing Mode B: VMB)

When frames including fast moving objects are processed, it would soon be clear that algorithms A1 and A2 produce a very physical and present second image sequence when viewed in VMA, and that when viewed in VMB too much of the optical subcarrier is visibly present in the processed image, competing with and de-resolving the strong image.

In order to ‘push’ the optical sub carrier below the conscious threshold, the key variables can be amended. However different cycle types will be optimal for certain image sequence types, such as:
dark images
fast moving images
bright slow moving images
very, very slow images.

It will be possible to optimise a certain cycle type to “push” the second image below the conscious threshold when viewed in VMB, but this may result in too weak a second image as compared to the strong image, which will result in a reduced depth effect. In such instances, the selection of a different algorithm will produce an initial rendering of the optical sub carrier which produces a more visually present second image, when viewed in VMA, and which is also subliminal when viewed in VMB.

Broadly speaking, a particular cycle type or particular cycle parameters will be selected to emphasise a temporal shadow effect that would otherwise be too weak, as may be the case with small, slow moving objects or with dark and/or low contrast images, and to de-emphasise a temporal shadow effect that would otherwise be too strong, as may be the case with large, fast moving objects or with bright and/or high contrast images.

The key variables can then be adjusted to maximise the physical presence in VMA and retain the subliminal quality in VMB. This is the optimal condition.

The selection of different cycle types, and the manipulation of the key variables may be a task best performed by an operator applying subjective evaluations. But it is important to note that the optimal condition can for present purposes, be understood and implemented as an objective criterion. This is because a subliminal image will be subjective for by far the majority of viewers, and a relative intensity and a relative ‘transparency and resolution ‘image footprint will combine to determine whether the optical subcarrier remains subliminal or has become overly consciously detectable, and just too plainly visible.

The frequency at which the strong image changes will ideally be half that of the temporal shadows—as will be the case in interlaced video formats in which the temporal shadow content varies on a field-by-field basis while the strong image changes on a frame-by-frame basis (two-fields per frame). For non-interlaced formats it may be necessary, or desirable, to obtain a similar effect by showing each frame twice, played back at twice the normal frame rate, with the temporal shadow content varying between successive frames.

### Application to Two-Channel Stereoscopic Image Sequences

As mentioned above, 2D motion picture sequences processed in accordance with the methods described above produce 3D-enhanced 2D sequences in which a sense of depth may be perceived by the viewer even when the sequence is viewed with one eye only—in fact the sense of depth may actually be increased when viewed with one eye. The reason for this is believed to be that the brain is always looking for subtle (and sometimes significant, particularly at close range) differences between the images received from both eyes. This is of course usually one of the main requirements for a 3D image. The identical nature of the images received by both eyes in the present processes and methods, is detected at a certain level and may undermine the full appreciation of depth that the time multiplexed insertion of temporal shadows along with the strong images, generates.

If each eye was to receive enhanced images of this nature, but in two separate left-eye and right-eye image streams (channels) with differences between them in their temporal shadow content, then the 3D produced from the 2D original, may become very powerful. That is, the strong image content of each channel is the same, original 2D sequence, but each channel includes temporal shadow content that is different from the other.

In order to achieve such differences for each eye, different optical subcarrier cycles can be used in each of the two channels. One preferred example of this is to apply the same cycle type to both channels, but to apply it to one channel playing in the normal, forward direction and to the other channel playing in the reverse direction. When both channels are played back together in the normal direction, the resultant optical subcarrier cycles in the respective channels will be different from one another.

Two-channel motion picture sequences of this type may be displayed using any conventional stereoscopic display technology, including dual-projector systems and autostereoscopic displays.

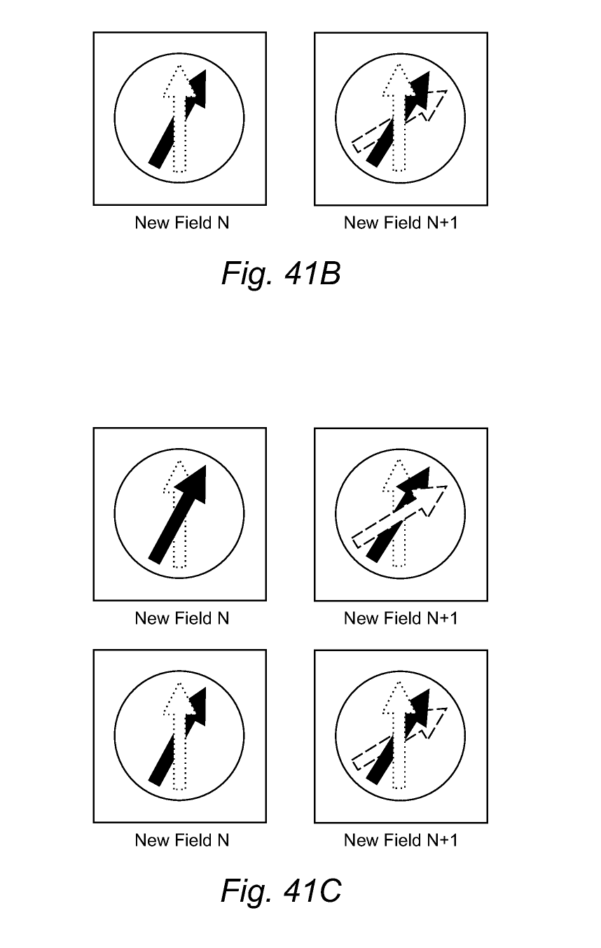

The effect of reversing the direction of one channel, before applying the optical subcarrier to both channels, is to create a two channel sequence that has the timing and positional relationships between the strong image and the temporal shadows in each cycle of one channel in reverse (see FIG. 41A), as compared with the normal (see FIG. 41B).

As a result when these two sequences, are now played in the same direction—the normal direction—the result is a two channel sequence, in which each channel is now different—but similar (see FIG. 41C). In this manner, we satisfy more of the cues and format requirements that the brain is used to receiving and is looking for.

This type of “reverse” processing may be further illustrated as follows. Consider an original video sequence in which the content of original fields OF1-OF4 is represented by the letters A, B, C and D:

| | OF1 | OF2 | OF3 | OF4 |
|---|---|---|---|---|
| Original content | A | B | C | D |

Suppose that cycle B1A is applied to the original sequence in the normal direction (A, B, C, D) and to the right channel in reverse (D, C, B, A), to produce two processed versions of the original sequence ((A) indicates temporal shadow content derived from OF1, etc.):

| | OF1 | OF2 | OF3 | OF4 |
|---|---|---|---|---|
| Original content, normal | A | B | C | D |
| Processed copy 1 | A | (A)B | C | (C)D |

| | OF4 | OF3 | OF2 | OF1 |
|---|---|---|---|---|
| Original content, reversed | D | C | B | A |
| Processed copy 2 | D | (D)C | B | (B)A |

Processed copy 1 is used as the left channel of a stereo sequence. Processed copy 2 is again reversed—“to its normal direction”—and is used as the right channel of a stereo sequence. The final processed stereo sequence is then:

| | NF1 | NF2 | NF3 | NF4 |
|---|---|---|---|---|
| Left channel | A | (A)B | C | (C)D |
| Right channel | (B)A | B | (D)C | D |

The strong image content of each channel is identical, but the temporal shadow content is different.

If these two left and right channels are then supplied to the brain through the left and right eyes respectively, the sense of depth will be very profound. Not only is each eye seeing an image that the brain will interpret as coming through both eyes, allowing each eye to generate a ‘stereoscopic mental image’ (SMI) on its own, the requirement of the brain to sense that each eye is receiving a different image is now also satisfied, giving an additional three dimensional depth cue to the SMI.

This makes for a very real and satisfying three dimensional, stereoscopic image, and will be one that has been derived from a monoscopic, two dimensional source.

An extension of this idea is to apply optical subcarriers to existing stereoscopic image streams. Inherently, there will already be differences between corresponding frames in the left and right channels of an existing stereoscopic image stream. Accordingly, the same or similar processing my be applied to both left and right channels and the temporal shadow content in each (left and right) pair of frames will be slightly different. Alternatively, the processing of one stream may be applied in the reverse direction to the other, as described above. In a further alternative, the left and right channels may be processed independently of each other to optimise the 3D enhancement obtained in each separate channel. As previously mentioned, an original stereoscopic motion picture sequence that is processed in this manner may comprise a “genuine”, “synthetic” or “pseudo-” stereoscopic sequence.

Broadly speaking, each channel of any existing stereoscopic sequence can be regarded as a single 2D sequence which can be processed to include temporal shadow content as described above for 2D sequences.

3D-enhanced stereoscopic motion picture sequences in accordance with the present invention may thus include:
sequences in which the left and right channels comprise identical strong image content from a single 2D image stream, but with differing temporal shadow content in each channel;
sequences derived from existing stereoscopic sequences, in which the original left and right channels are modified to include temporal shadow content.

Special condition: The optical subcarrier cycles as described above are keyed to the movements of objects within each image sequence. When the vector of the movement in the vertical axis is too great, then the optical subcarrier cycle may need to be modified. Otherwise, it can produce an image that challenges the brain's ability to resolve it stereoscopically.

A preferred modified optical subcarrier cycle involves creating a temporal shadow image from the complete content of the current original field OFn, which is degraded and partially transparent as previously described and which may preferably increase in transparency towards its edges. The temporal shadow image is shifted laterally to the left and/or right, typically by about 2%-5% and blended with original field OFn to create the new field NFn. These two temporal shadow images are then used in the prevailing optical subcarrier cycle for the duration of the movement in question. That is, the laterally shifted temporal shadow(s) derived from the current field are used in place of the temporal shadow(s) that would otherwise have been derived from preceding and/or succeeding fields and with the same relative intensities that would otherwise have been applied to those temporal shadow(s).

The inventor believes that this work introduces a new understanding of vision, beginning with the observation that it is due in large measure to the monoscopic (single lens camera) mode of recording images through the end of the 19th century and all through the 20th century, that humanity as a whole has disconnected mentally, and culturally, with the true nature of its own naturally possessed stereo vision. The following discussion then describes the true nature of the images that we actually see, briefly placing this reality in the context of the development of our conscious development, through the history of modern man and woman.

The implications of this new reality for 3D imaging are then identified, which can be related to the foregoing description of digital processes that can electronically introduce changes into the image stream of a 2D moving picture, in order to create the illusion of three dimensionality even given the single lens recording mode of the original images and, as importantly, to introduce the appearance of depth, even into a single channel, 2D image display.

This discussion is the result of hypotheses that lead to practical experimentation, and thereafter practical knowledge and, together with the foregoing description, presents the practical knowledge and the technology that has emerged from it. It also presents the scientific knowledge that has been tested and supported by the practical and experimental knowledge that the initial hypotheses gave rise to. As such, it assists in establishing the context of the foregoing technology description.

The foregoing description sets out a specific set of optical subcarrier cycles which when applied to a video stream (or to a celluloid (film) stream or the like), allows an original two dimensional moving image, to be converted into a more three dimensional equivalent image—or at the very least a depth enhanced, equivalent image.

The various cycle types cause changes to be made to the content of the image stream, that subsequently produce a more complex picture that provides the brain with depth cues. These introduced changes can be viewed as frames flowing with a moving sequence or on a frame by frame basis, at which point one is regarding a stationary image of either stationary objects, or a stationary image of objects in motion.

These changes to the image stream, are intended to be introduced to the viewer just at or just below the conscious threshold. They are very deliberately intended to be almost but not quite subliminal, so that the viewer registers them more greatly at the neuro-cognitive level and a little less at the conscious optical level. They are intended to be viewed in a sequence of moving images—as occurs in normal filming and in subsequent cine/video display.

Three dimensional photography has always involved creating two images: one to be viewed by the left eye and one to be viewed by the right eye—two images of the same object or objects, but with changes between the two images. These changes are “encoded” depth cues that the brain detects, “decodes” and understands as meaning that the objects exist and are arranged three dimensionally in space.

Such stereoscopic image pairs require either two cameras to create the initial pictures, or they may be synthesised from a single image by any of a number of known techniques.

If a person viewing a real three-dimensional scene closes one of their eyes, their perception of the scene does not suddenly become ‘flat’, but they do lose their impression of spatial three dimensionality, with the brain then relying on other two-dimensional cues within the image to help it interpret the full meaning of the scene. It has generally been accepted that only pictures taken from (at least) two reference points can provide the brain with this spatial depth information.

It has generally been accepted, therefore, that no motion picture sequence or stationary image, when being viewed through a single eye, has been able to provide a genuine ‘impression of three-dimensionality’; i.e. the impression that the viewer receives that the image is essentially of a volume and not a flat plane. More significantly, a single axis image does not allow the viewer to receive the impression that the image is of solid objects, that are themselves arranged and perhaps moving in a volume relative to each other. This has always required two eyes.

This has been a condition of classical three dimensional viewing practices and theories for well over a century, remaining in use up to the present day, stipulating that two observer reference points—two eyes/binocular vision—are required to see 3D images and to understand them three dimensionally.

It is of course possible to insert three dimensional cues into 2D images—both stills and moving sequences—but these are never able to satisfactorily generate in the viewer a palpable sense of looking into a volume, and a sense of observing objects positioned spatially, relative to each other within this volume. This is the requirement of a 3D image, that it makes the observers ‘feel’ the extent of the volume that the image is trying to represent and convey.

It has also always been true that conveying this sensation to the viewer has always required depth cues, represented in the differences between the two presented pictures of the same image (parallax), and therefore it could not be achieved by depth cues introduced into a single image alone.

It has also been generally accepted that these two images must be seen by both eyes separately.

That is, it has previously been generally accepted that both two images and two eyes are required to perceive and experience, the spatial volume aspect of a three dimensional image.

In contrast to this generally accepted view, the central hypothesis underlying the present invention is that “seeing” is “understanding”, that it is mainly cognitive and not mainly optical, and that it is far more the consequence of what occurs in the occipital lobes of the cerebral cortex, than it is what is represented on densely packed cells of the retina.

The introduction of the optical subcarrier information to a 2D image stream as described above allows the viewer to perceive the 3D volume intended to be conveyed by the image, when viewed in a two dimensional medium by both eyes simultaneously. Furthermore, when viewed with a single eye—with the other eye closed—not only does the image retain the sensation of the spatial dimensions of the volume intended to be conveyed by the image, but when viewed with one eye the clear sense of volume as viewed and appreciated with both eyes may actually be increased.

The consequence of this is that an ordinary 2D display unit such as a television—whether a cathode ray tube, plasma or LCD device, can display moving images with enhanced depth that appear more three dimensional to the viewer, without any changes being made to the display technology or with any modification made to the viewer's eye; i.e. no glasses or other artificial aids are required to be worn by the viewer, and no lenses, parallax layers or the like are required on the display.

The present inventor's theory underlying the invention may be referred to as “the comprehension of sight”. This theory seeks to place consciousness and the human brain that produces or contains it at centre of perceived reality, and to recognise the role of the brain as both the architect and stage manager of our context and frames of reference. In other words, without a thorough interrogation of the part that our brains are playing both visibly and invisibly, there is no understanding of our understanding of anything. A key point of this theory may be stated briefly: you see with your brain and not with your eyes.

The history of human art is actually the history of human cognitive evolution; the development of our conscious minds can be traced through the history of art from cave wall etchings to expressionism and modern art.

But art does not only mirror cognitive, intellectual evolution, it also reveals the cognitive and intellectual limits of the conscious minds of both of the individuals who created it and within the society that created those individuals.

For example, the development of mirrors and lenses and the arrival of a technological understanding of how to use them to project an image onto a smaller canvas allowed Renaissance artists to fully understand the principles of linear perspective. Further, it was not until the advent of photography that artists realized that horses always keep one hoof on the ground when galloping. This also revealed the persistence of vision—itself a consequence of the refractory period that the response times of the retinal cells hardwire into the biology of the process of seeing: our eyes do not respond fast enough to allow us to see an image that has a very short duration. Because of these parameters—built upon our biology, biochemistry and cognitive psychology—we could not see without a multiple blur of four legs the distinct image of a horse at speed, and so we imagined what we saw: the horse almost flying with all limbs in the air.

From this it can be seen that, when looking at horses, our ancestors did not ‘see’ what they actually saw; they saw what they thought they were seeing.

The inventor's present theory recognises another aspect of our cognitive psychological nature, which will be referred to now as our “cognitive cursor”, which hitherto has not been given its due prominence in our understanding of our nature.

The preceding description of the preferred embodiments of the present invention concerns the creation of 3D-enhanced moving images from 2D sources. The following discussion is an analysis of what actually constitutes a real 3D image, the truth of which has long been hidden. The comprehension of sight is how the vast majority of sighted human beings around the world actually see. And we “see”, that is we comprehend, by means of our cognitive cursors.

This term “cognitive cursor”, is a hypothetical neurological faculty, constructed as a model within this theory. But this faculty is important, for it allows the brain to limit the processing requirements, being made upon it at any given time. The visual domain is the most rapidly changing environment and therefore source of greatest stimuli that the body routinely encounters. The cognitive cursor allows us to concentrate on the thing that is most interesting to us in our current field of view. This allows the brain to relegate a great deal of the visual domain, to a second tier processing protocol; i.e. we see it, but we are just not paying as much attention to it.

This has ordinarily and thus far been referred to us our “focus of attention”. But the cognitive cursor upgrades this concept, because it reminds us that we are not “seeing” everything that we “see”. That is, we do not actually see—consciously register—everything that we are looking at. The brain only puts the greater neurological work (what may be referred to as “level one processing protocol”) into seeing what the cognitive cursor highlights for it. The rest of what we see is, it is postulated here, a projection from within the brain for the brain.

Each one of us has a cognitive cursor: as you read the words of this text you are using your cursor to highlight each word and perhaps the word in front and the word behind. This cursor calls up powerful “neurological sub-routines” (NSRs) that allow you to read and to understand the meaning of each word, one after the other, leading to an understanding of the meaning of the sentence.

You can use the cognitive cursor to highlight a larger area, and if you try right now as you read these words, you can widen the aperture of the cursor, and try to make yourself aware of a paragraph at a time, you may have to lean back a little to take the paragraph size fully in. You can feel yourself now looking at a whole paragraph at a time, but such is the complexity of reading that when we look at a paragraph at a time, it is like giving a computer application a data file to process that is too large for it, and the application slows down and fails. Human biological nature is such that most people cannot “read” a paragraph at a time, although we can “see” a paragraph at a time.

It is important to note that, when we look at a whole paragraph, it is not that the retina cannot register all of the words clearly enough to read them. The words are clear, it is just that we cannot understand them. We can see all of the words in the paragraph clearly enough to see them as one block, it is just that we cannot understand. Very few of us can read a paragraph at a time; even a line at a time is usually a case of our reading word by word very quickly. But the point here is that we can see a paragraph at a time, we can comprehend its place as a body of text of printed letters and punctuation on the page in front of us.

So we have used the cognitive cursor to widen the area processed by our NSRs for fuller comprehension, from the “highlighted” word which allows us to both “see” the word on the page, and “see” the meaning of a world being created by the author—one word at a time. So when we widen the cognitive aperture, we see the paragraph, but lose sight of the meaning.

Now widen the cognitive cursor's highlighted area again, to this time include the entire page, if the page is not too large, it should not be too difficult to keep it in focus. Now it is clear that it is a page of printed words in a book, or pamphlet, or on a computer screen. We now see the meaning of its place in the room with us. But of course we cannot read the words.

Now we will widen the cognitive cursor's highlighted area, one further time, and as we do so, we will come to the main point of this discussion that underpins the use of optical subcarriers to convey an enhanced perception of 3D depth.

If we widen the cognitive cursor to the page and widen still further by about 5 cm either side left, right, top and bottom, and now hold the page up to about the height of your nose and about arm's length in front of you (if reading at a computer it should be pretty much where the screen is), then as you understand this highlighted area, you will be forced to keep the page well “understood” but also to allow all the objects behind the page, at the top, sides and bottom, to be “understood”. As you do so you will notice that they are all slightly blurred, some only slightly blurred, on account of being slightly out of focus, but they will all be seen as double images.

Now take a pencil (or pen) and hold it between you and the page, whilst not looking directly at the pencil but at the page behind it—you will see two pencils. Now slowly lower the pencil to your chest or lap, whilst still looking at the page, and whilst still comprehending this established zone. As you lower it to your chest, you should now be very aware of the pencil. You will understand that the pencil is in front of the thing or things that you are looking at, and you will be very aware that you are still seeing two pencils.

It should now also become clear that there is nothing strange about seeing two pencils; this is after all a three dimensional space that both the pencil and the page are in. Your brain is telling you that the double image of the pencil is how you know that it is, in fact, in front of the page.

Now allow your self to “see”, to realise that it is not just the thin pencil that is double—you see two clear images of the pencil—but your much thicker and irregular hand that is holding the pencil is also a double image. But it is not double like the pencil. If you allow—whilst still looking at the page—the cursor to increase the “area of full comprehension” you will notice something interesting. If you lift the pencil so that your hand now breaks into the area of the page behind it, while constantly looking at the page, but allowing yourself to begin to see this increased area of comprehension, you will notice that the two images of your hand overlap, but that they dissolve at their overlapping edges, to allow whatever object is behind them—in this case the page—to come through.

The point being made here, is that this constant presence and mixture of double images and edge outlines just outside the area of full comprehension and single images and single outlines inside the area of full comprehension, is actually how we see in 3D, it is how we see and it is what we see constantly, continually and continuously. This applies not just to the page and the things that are at arm's length and here in the room with you. If you go now to a window, you may for the first time start to see that the vast majority of every scene we survey with both our eyes, is a double image: trees behind chimneys, clouds behind trees—edges, ledges, not great displacements, but everywhere, and suddenly the central strut in a window frame is wide apart, and we realise now that these double images slip quietly into and out of, our comprehension of the image.

Returning to the relationship between art and perception, we have probably never seen a single painting of the world as it is actually seen through two eyes.

If you return briefly to the highlighted area of full comprehension, about 5 cm above the page, as soon as you comprehend double images of an object above the page, they become a single image of the single object—as soon as you use your cognitive cursor to highlight just the area of the object. You now understand the object—what it is, where it is—and as you do so, you will be aware that the page (now in front of it) has itself become a double image.

As we look at any object, it is “caught in the crosswires of both our eyes” and it comes then into a single image, but this amounts to less than about 20% of any image in front of us, at any given time.

This is how we see: our images are always full of double images, but they are not distracting. On the contrary, they are not distracting because we understand what these double images mean. They mean depth, they mean distance: they are the reality of three-dimensional seeing.

No artist has thus far painted a picture of the images that we would actually see with two eyes if we were standing in his shoes. It is not the case that a two dimensional representation of this is not possible, because it is quite simply a picture in which the main subject of the picture has a single outline and everything else has a double edge with sometimes solid and sometimes dissolved outlines.

The closer to the artist/viewer the main object in the painting is, the greater the is displacement between the double images/edges of secondary objects in the picture. Those secondary objects in the picture or painting, that stretch between the subject and the horizon, will have an increasing displacement between their double images/edges the further away they are. Of course unlike reality, when you can choose to look at the closer objects, and bring them in their turn into convergence as a single image, making them the subject of your view, you cannot: you cannot visually explore a painting as just described three dimensionally.

But such a painting would seem wonderfully three-dimensional from one point of interest; when you look directly at the chosen subject of the painter, then all of the supporting objects will fall beautifully into three dimensional position.

At present we can explore a “normal” painted canvas by looking at everything and imagining the depth of the scene. Such a painting as described here would give a much greater sense of three dimensional reality, but at the price of making one thing clearly the dominant subject of the painting.

The fact that such paintings have never been created speaks of our evolving human consciousness. As our brains are stimulated more and more, the area of full comprehension is slowly increasing—our cognitive cursor, is getting larger.

The view of the present inventor is that it is the fact that almost all photography is two dimensional—taken from a single axis and perspective—that has hidden this truth of how we really see from us for so long. It is interesting to note that in stereo photography this doubling of images does occur, but the method of viewing such images is so intrusive that the degree of mental relaxation required to allow one to widen the area of full comprehension is not readily available at such times. But it is the absence of a single painting, picture or photograph that has been created specifically to give us a two dimensional representation of our three dimensional sight that is scientifically, historically and culturally interesting. Such a depiction would be an attempt to recreate images that we actually see in reality. The absence of such a depiction is considered by the present inventor to be profound and noteworthy.

Previous research by the present inventor demonstrated that the brain does not assign an understanding to which eye is supplying which image to it: it just understands that the left most images are to be found on the left of the body, and the right most images are to be found on the right. In other words, if the optic chiasmata of the brain re-routed the optic nerves—swapped them over—the brain would almost certainly still allow us to understand that things on the left of the image are closer to the left hand, even though the controlling motor neurons for the left hand would now be in the other hemisphere.

This research allowed the inventor to develop a model that entailed sending the left and the right eye images to both eyes at the same time, thus allowing the brain to receive effectively four sets of amalgamated images through both eyes, and to understand them as two images, one received from one eye, and the other received through the other.

For example, if the left and right views of a stereoscopic pair of images are superimposed to create a single composite image in which the two original images are blended into one, the single composite image will comprise a complex set of single outlines, thickened outlines and doubled outlines of all of the objects and edges in the picture. When presented on a standard (2D) display, both eyes of a viewer then carry this composite image through the retina, optic nerve and neuro-optic pathways, deep into the occipital lobe. The brain is then in effect receiving four images—two from each eye—derived from the single composite image.

The model based on this prior research postulated that the brain would in fact view these four images, which are in fact two identical composite images coming from both eyes, as one image, but as seen twice, separately, by both the left and the right eye. The four images are understood as two images, one coming from one eye and the other coming from the other. When these two images are similar enough to create double edges and convey changes that correspond to parallax differences, their presentation allows the brain to in fact understand that it was actually looking at just one image, but that it obtained one perspective from the right eye, and a different perspective from the left eye.

The two combined images on the single screen, are conveyed as four images to the brain, which sees them as two images, giving two perspectives on the single object.

The two images presented to the brain are understood by the brain as a single image coming from two different sources (left eye and right eye). This is because the brain combines the four images into two images, and then also discerns that these two are the standard input that it receives when it is looking at single three-dimensional image.

As a result, a single is image is understood to be before the viewer's eyes, but now it is accompanied with a gentle, but clear sensation of enhanced depth.

In the preceding description of the use of optical subcarriers cycles to produce 3d-enhanced motion picture sequences, multiple images of this general type are presented to the brain in a way intended to lower their direct, conscious image profile.

When considered purely in stereoscopic terms, this should not give a satisfying 3D image—it should merely create a window effect. This is because both eyes are receiving exactly the same image. As discussed earlier, it has previously been generally accepted that both eyes must receive a different version of an image for the brain to understand the meaning of depth in the image.

However, motion picture sequences incorporating the present optical subcarrier cycles, presented identically to both eyes, do give a satisfying 3D effect, and when analysed through a broad neurological model of cognition, it can be seen why. The left and right eye views of the sequences are combined by the brain in a way that allows the brain to consider the resultant combined image as though one eye had received the temporal shadow and other eye had received the strong image.

When the left eye alone sees a 3D object, with the right eye closed, it is represented in the visual cortex, located at the rear of the brain, as a single image. When the left eye and right eyes both see the object, it is represented within the visual cortex as two separate images. However, at a deeper level of visual perception and at a further specific region within the cortex, these images are combined and the differences measured and understood as one item: the position of the object relative to the viewer. This is how we “understand”—not “see”, but “understand”—stereoscopic images; that is to say, how we understand the meaning of a stereoscopic image over a two-dimensional one.

As previously discussed there is no rotational parallax between the two (left eye and right eye) views of the “strong image sequences” in the 3D-enhanced 2D motion picture sequences described herein. There is, however, slight rotational parallax within frames between elements of the strong image content and their corresponding temporal shadow(s). But more importantly, it is the complex of edges—the single edges, thickened edges, blurred edges and double edges—created by the relationships between the strong image elements and their corresponding temporal shadows that the brain sees as being made up from the contribution of both eyes.

WO2008/004005 (see in particular page 29, line 19 to page 33, line 17 and page 38, line 9 to page 41, line 11) includes further discussion of experiments and postulations by the present inventor that are believed to support the cognitive model underlying the processes of the present invention. As previously noted, WO2008/004005 is concerned particularly with stereoscopic (two-channel) motion picture sequences, and most particularly with “pseudo-stereoscopic” sequences derived from original 2D (single-channel) sequences. Such pseudo-stereoscopic sequences rely on “time parallax” and lateral shifting of the respective left and right eye views derived from the original 2D sequence. By contrast, the present invention provides enhanced depth perception even in single-channel 2D motion picture sequences, without any lateral shifting, but a satisfying appreciation of depth still comes about because rotational parallax is “seen” at the higher cognitive level necessary because the difference within the image seen by both eyes, is perceived and understood at these cortex sites, as the difference between the images seen by each eye. The high frequency cycling of different relationships between strong images and temporal shadows also reinforces the brain's understanding that these different images and the perspectives they convey are arriving from different eyes.

A further enhancement that can be made to the processes etc. described herein and their resultant effectiveness will now be described.

It is sometimes the case that motion picture sequences are made of very fast moving events, in which cases the edge separations between the strong images and the temporal shadows may be too great for the brain, with its expectation of the parallax separation, to identify the separation produced by the optical subcarrier cycles.

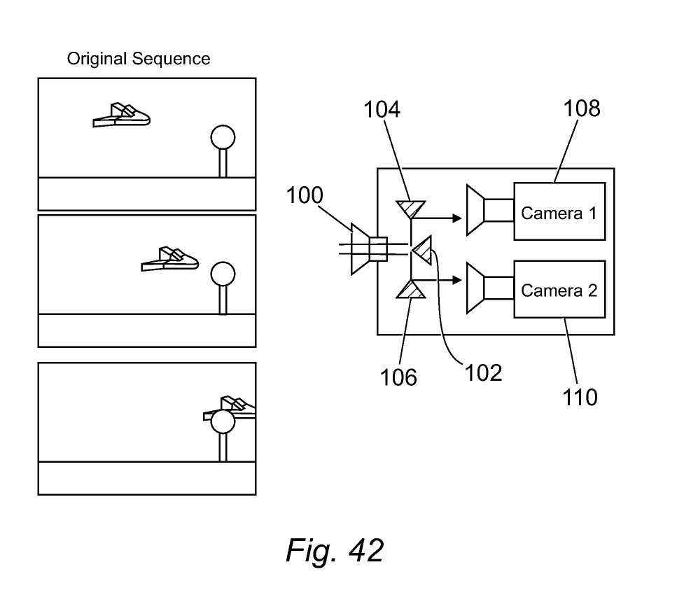

In such cases, an alternative optical recoding configuration may be used, as illustrated schematically in FIG. 42. An image is captured by a primary lens system 100. A beam splitting arrangement such as prisms 102, 104 and 106 splits and diverts the image into the lens systems of two recording cameras 108, 110. One camera 108 is set up as “normal”, and the second camera 110 is loaded with very fast film, or high-sensitivity sensors in the video equivalent, and with optical shutter speeds that can be varied upwards as required.

In FIG. 42 the two cameras are recording the exact same view, but the second camera 110 is running at a faster frame rate.

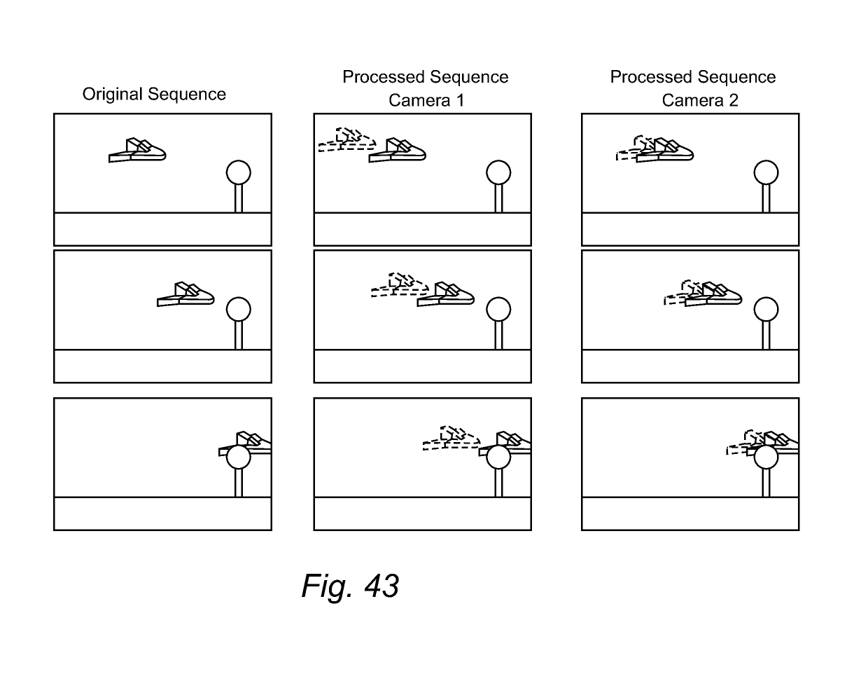

As a result, the separation between the strong image and the temporal shadow can be controlled, as illustrated in FIG. 43, because of the differing frame rates and the consequently differing displacements between objects and their temporal shadows when sequences recorded by the two cameras are processed in the manner previously described. If a processing system that introduces the optical subcarriers is also present on the set, it will allow the director and cameramen to determine the quality of the image—in particular the quality of the three dimensional or depth enhanced, image—before committing it to a final “take”.

Temporal shadow content may be derived from the higher frame rate sequence for incorporation into images in the normal frame rate sequence, so as to obtain a smaller displacement between temporal shadow content and strong image content than would be possible using the images available from the normal sequence. For example, if the second camera is running at twice the speed of the first camera, two sequences would be obtained as follow:

| Camera 1 | OF1.1 | | OF1.2 | | OF1.3 | | OF1.4 | |
|---|---|---|---|---|---|---|---|---|
| Camera 2 | OF2.1 | OF2.2 | OF2.3 | OF2.4 | OF2.5 | OF2.6 | OF2.7 | OF2.8 |

New field NF2 could, for example, derive its strong image content from OF1.2 and its temporal shadow content from OF2.2 and/or OF2.4, having a smaller displacement relative to the strong image than equivalent temporal shadow content derived from OF1.1 and/or OF1.3.

A similar effect could be obtained without using two cameras by deriving the temporal shadow content from OF1.1 and/or OF1.3 and shifting the temporal shadow content to the left or right to reduce the relative displacement when it is blended with OF1.2.

Optical subcarrier cycles of the type described herein may be used to create motion picture sequences with greater and lesser 3D depth enhancement, and sometimes with greater and lesser resolution loss. Creative application of the cycles will enable the production of motion pictures that have a clear sensation of depth, while minimising of the loss of resolution that the cycles can produce. To this end, the application of the cycles may be varied within a scene, or even within a single shot. The specific nature of the material that is processed will undoubtedly influence the selection of which cycle is appropriate to produce the most effective end result in any particular circumstances.

3D-enhanced motion pictures according to the present invention are capable of producing a powerful depth effect when viewed on a normal 2D display system in a way that is believed never to have been seen before. The processes by which the enhancements are produced introduce changes into the picture, that without a clear understanding of the true nature of stereo vision—not just at the optical, but at the neuro-cognitive level—these changes might be regarded merely as undesirable digital artifacts that produce a needlessly more complex and degraded image. Such changes are counter-intuitive.

Furthermore the time multiplexing produced by the optical subcarrier cycles creates a high frequency and highly sophisticated “optical complex” of alternating and blended strong image and temporal shadow content, which at times produces, in effect, three different perspectives of the same object. This is an approach which, it is believed, has not been utilized before, based as it is, on a new scientific theory of cognitive perception.

These kinds of changes are what video operators and film editors might normally be expected to try their hardest to remove. When viewed at frame by frame level, most video engineers and film editors, would be horrified at the images and might imagine that the video equipment used to produce them was either damaged or malfunctioning or being misused. It would only be when viewed at playback speed, that those same editors and video operators would understand that those blurred and double edges were producing a cumulative 3D-enhancement effect.

The temporal shadows of the present invention are not the same as motion blur: they are very clearly, at times, double images. They are the result of combining two or three exposures—not a single extended exposure—and they produce two images, replicating the actual viewing experience.

The optical subcarrier cycles of the present invention allow the viewer to slip the different perspectives past the brain's conscious scrutiny, only to be detected and understood at a deeper level of processing in the neuro-cognitive chain.

It is also the case that the set of processing methods used to introduce the optical subcarriers comprise specific sequences of steps that are believed never to have previously been used in video or film. Without the model of neuro-cognition presented here, the changes introduced by the optical subcarriers would likely be considered a retrograde step in the creation of any video or film product. It is the direct intervention of the brain's own processing pathways that take these transformations and render them useful and meaningful.

The present invention provides new technology founded in new science and is based upon practical experimentation. The observations recorded are based on actual clinical and experiment observations.

Motion pictures rely on an illusion that is supported by the brain. The present invention demonstrates that the brain has spare capacity even when processing the visual domain—our most challenging sensory input stream—and that this spare capacity is capable of supporting a more realistic and satisfying rendering of the original illusion, transforming the observation of a rapid succession of still images as a moving, living image, into an additional illusion, of a moving image within a scene with recognizable depth. The capacity of the brain to sustain this additional illusion, if its rules are observed and adhered to, is at the heart of this new technology, and the observation that the brain has evolved down the line of greatest economy of processing, is at the heart of this new science.

One of the benefits of the present invention is that it deals with one of the main problems with conventional stereoscopic motion pictures: the decoupling of the “accommodation” and “convergence” of the eyes.

When our eyes look at objects that are relatively close and then relatively distant, our eyeballs literally rotate in their sockets to bring the objects into the centre of both retinas. This is called convergence. The lenses also change shape to bring the objects into focus. This is called accommodation. Accommodation and convergence, always occur together. However, in conventional stereoscopic motion pictures, the entire 3D illusion is based upon a decoupling of this natural occurrence When objects appear to fly from the screen into the audience, the viewer's eyes rotate, but their lenses must remain focused on the plane of the screen. This is unnatural and it makes the brain uneasy, as it begins to notice that something is not quite right.

The present invention does something quite different: the eyes are always focussed on the screen, which is where the eyes have converged upon, but those objects that are behind other objects appear behind because the viewer is presented with a subliminal double image, which tells the brain that the objects are in a plane that the eyes have not converged upon.

This is a completely different depth effect from conventional stereoscopy, and it allows the eyes to stay focussed on the plane that they are converged on while the brain still perceives a sensation of depth. This is much more natural, and it results in no eyestrain.

It will be understood that the particular embodiments of the invention as described here in are exemplary and not limiting. Variations, modifications and improvements may be incorporated without departing from the scope of the invention.

1. A 3D-enhanced 2D motion picture sequence comprising:
a single channel of sequential images;
wherein each image in said channel comprises primary image content representing a scene consisting of a plurality of elements;
wherein at least some images in said channel further include temporal shadow image content, said temporal shadow image content in a first image comprising at least one of a degraded and a partially transparent image of at least one element of said primary image content corresponding to a view of said at least one element as seen in the primary image content of at least one other image from said channel; and
wherein said temporal shadow content of said images varies within a series of successive images in a cyclical manner.

2. A motion picture sequence according to claim 1, wherein said temporal shadow content of said images varies cyclically within any given series of successive images in terms of at least one of:
the sequential position(s) relative to a current first image of the other image(s) from which any temporal shadow content of the current first image is derived;
the number of other images from which any temporal shadow content of the current first image is derived; and
the relative intensities of the primary image content and any temporal shadow content within the current first image.

3. A motion picture sequence according to claim 2, wherein, in at least one series of successive images, images including temporal shadow content derived from at least one preceding image or at least one succeeding image alternate with images including temporal shadow content derived from both preceding and succeeding images.

4. A motion picture sequence according to claim 3, wherein the temporal shadow content of those images that include temporal shadow content derived from at least one preceding image or at least one succeeding image alternates between temporal shadow content derived from at least one preceding image and temporal shadow content derived at least one succeeding image.

5. A motion picture sequence according to claim 3, wherein the relative intensities of the primary image content and the temporal shadow content in those images that include temporal shadow content derived from at least one preceding image or at least one succeeding image are in the ratio 50:50 or 65:35.

6. A motion picture sequence according to claim 2, wherein, in at least one series of successive images, images including no temporal shadow content alternate with images including temporal shadow content derived from at least one preceding image and/or at least one succeeding image.

7. A motion picture sequence according to claim 8, wherein the temporal shadow content of images that include temporal shadow content derived from at least one preceding image or at least one succeeding image alternates between temporal shadow content derived from at least one preceding image and temporal shadow content derived at least one succeeding image.

8. A motion picture sequence according to claim 7, wherein the relative intensities of the primary image content and the temporal shadow content in those images that include temporal shadow content derived from at least one preceding image or at least one succeeding image are in the ratio 65:35.

9. A motion picture sequence according to claim 6, wherein the temporal shadow content of images that include temporal shadow content is derived from at least one preceding image or from at least one succeeding image.

10. A motion picture sequence according to claim 9, wherein the relative intensities of the primary image content and the temporal shadow content in those images that include temporal shadow content derived from at least one preceding image or from at least one succeeding image are in the ratio 50:50.

11. A motion picture sequence according to claim 6, wherein the temporal shadow content of images that include temporal shadow content is derived from both preceding and succeeding images.

12. A motion picture sequence according to claim 3, wherein the relative intensities of the primary image content and the temporal shadow content in those images that include temporal shadow content derived from both preceding and succeeding images are in the ratio 60:23:17 or 60:20:20.

13. A motion picture sequence according to claim 2, wherein, in at least one series of successive images, images including temporal shadow content derived from at least one succeeding image alternate with images including temporal shadow content derived from at least one preceding image.

14. A motion picture sequence according to claim 13, wherein the relative intensities of the primary image content and the temporal shadow content are in the ratio 65:35 or 70:30.

15. A motion picture sequence according to claim 2, wherein, in at least one series of successive images, the temporal shadow content of the images varies in a repeating cycle in which a first image includes temporal shadow content derived from a succeeding image, a next, second image includes temporal shadow content derived from a succeeding image, and a next, third image includes temporal shadow content derived from a preceding image.

16. A motion picture sequence according to claim 15, wherein the relative intensities of the primary image content and the temporal shadow content in the first image are in the ratio 50:50, and the relative intensities of the primary image content and the temporal shadow content in the second and third images are in the ratio 70:30.

17. A motion picture sequence according to claim 1, wherein the temporal shadow image content of images is determined on the basis of the degree of displacement between corresponding elements of respective images.

18. A motion picture sequence according to claim 17, wherein the temporal shadow image content of images is determined on the basis of multiple displacement threshold values or multiple displacement ranges.

19. A motion picture sequence according to claim 17, wherein the degree of degradation and/or the degree of transparency of the temporal shadow image content in images depends on the degree of displacement between corresponding elements of the respective images.

20. A motion picture sequence according to claim 19, wherein the degree of degradation and/or the degree of transparency of the temporal shadow image content in an image is greater for elements having a greater degree of displacement between corresponding elements of the respective images.

21. A motion picture sequence according to claim 1, wherein the temporal shadow image content of selected images corresponds to all of the primary image content of respective other images.

22. A motion picture sequence according to claim 1, wherein respective first images and other images from which temporal shadow content of the first image is derived are immediately adjacent to one another in the sequence of images.

23. A motion picture sequence according to claim 1, wherein, for selected images, temporal shadow content is derived from the complete content of a current image, shifted laterally to the left and/or right, and blended with content of the current image in place of the temporal shadow content that would otherwise have been derived from preceding and/or succeeding images.

24. A motion picture sequence according to claim 1, wherein, for selected images, temporal shadow content is derived from a higher frame rate version of the same sequence, so as to obtain a smaller displacement between temporal shadow content and strong image content than would be possible using the images available from the same sequence.

25. A motion picture sequence according to claim 1, wherein temporal shadow content derived from a preceding and/or succeeding image is laterally shifted to the left or right to reduce the displacement between temporal shadow content and strong image content.

26. A motion picture sequence according to claim 1, wherein each image is one of a plurality of fields, two or more of which successive fields together constitute a complete image frame.

27. A motion picture sequence according to claim 1, wherein each image is a complete image frame.

28. A motion picture sequence according to claim 1, wherein the temporal shadow content of said images varies at a frequency higher than a frame rate of the motion picture sequence.

29. A motion picture sequence according to claim 1, wherein the temporal shadow content of said images varies at a frequency of 50 Hz to 60 Hz.

30. A 3D-enhanced stereoscopic motion picture sequence comprising:
a first channel of sequential images intended for viewing by one of a viewer's left and right eyes;
a second channel of sequential images intended for viewing by the other one of the viewer's left and right eyes; and
wherein each of said first and second channels comprises a 3D-enhanced 2D motion picture sequence according to claim 1.

31. A 3D-enhanced stereoscopic motion picture sequence according to claim 30, wherein the primary image content of the first channel is identical to the primary image content of the second channel and the temporal shadow content of the first channel is different from the temporal shadow content of the second channel.

32. A 3D-enhanced stereoscopic motion picture sequence according to claim 30, wherein the primary image content of the first and second channels comprises genuine, synthetic or pseudo-stereoscopic content and the temporal shadow content of images in the first and second channels is derived from other images in either of the first and second channels.

33. A motion picture sequence as claimed in claim 1, encoded in a predetermined format and recorded in any tangible medium.

34. A method of producing a 3D-enhanced 2D motion picture sequence comprising a single channel of sequential images, wherein each image in each channel comprises primary image content representing a scene consisting of a plurality of elements, the method comprising:
in at least some of said images, blending temporal shadow image content with said primary image content, said temporal shadow image content for a first image comprising a degraded and/or partially transparent image of at least one element of said primary image content corresponding to a view of said at least one element as seen in the primary image content of at least one other image said channel; and
varying said temporal shadow content of said images within a series of successive images in a cyclical manner.

35. A method according to claim 34, comprising deriving said temporal shadow content and blending primary image content and temporal image content in sequences of images so as to produce motion picture sequences.

36. A method of producing a 3D-enhanced stereoscopic motion picture sequence comprising a first channel of sequential images intended for viewing by one of a viewer's left and right eyes and a second channel of sequential images intended for viewing by the other one of the viewer's left and right eyes, comprising producing each of said first and second channels as a 3D-enhanced 2D motion picture sequence using the method of claim 34.

37. A method of producing a 3D-enhanced stereoscopic motion picture sequence according to claim 36, comprising producing first and second channels in which the primary image content of the first channel is identical to the primary image content of the second channel and the temporal shadow content of the first channel is different from the temporal shadow content of the second channel.

38. A method of producing a 3D-enhanced stereoscopic motion picture sequence according to claim 36, comprising producing first and second channels in which the primary image content of the first and second channels comprises genuine, synthetic or pseudo-stereoscopic content and the temporal shadow content of images in the first and second channels is derived from other images in either of the first and second channels.

39. A system for producing 3D-enhanced 2D motion picture sequences comprising a single channel of sequential images, wherein each image in said channel comprises primary image content representing a scene consisting of a plurality of elements and temporal shadow image content, said temporal shadow image content in a first image comprising a degraded and/or partially transparent image of at least one element of said primary image content corresponding to a view of said at least one element as seen in the primary image content of at least one second image from said channel, said system comprising:
an input for receiving as input sequences of sequential images;
a data store for storing selected ones of said images;
a comparator for comparing the content of stored images to determine temporal shadow image content;
an integrator for blending temporal shadow image content with primary image content of said images to create modified images comprising said primary image content and said temporal shadow image content, such that said temporal shadow content of said images varies within a series of successive images in a cyclical manner; and
an output for generating as output sequences of said modified images.

40. A system according to claim 39, wherein said comparator and said integrator are adapted for deriving said temporal shadow content and blending primary image content and temporal image content in sequences of images so as to produce motion picture sequences.

41. A computer program encoded on a data carrier for producing a 3D-enhanced 2D motion picture sequence comprising a single channel of sequential images, wherein each image in each channel comprises primary image content representing a scene consisting of a plurality of elements, comprising:
computer readable program code for, in each image, causing blending of temporal shadow image content with said primary image content, said temporal shadow image content for a first image comprising a degraded and/or partially transparent image of at least one element of said primary image content corresponding to a view of said at least one element as seen in the primary image content of a at least one other image from said channel, such that said temporal shadow content of said images varies within a series of successive images in a cyclical manner.

42. A computer program according to claim 41, adapted for deriving said temporal shadow content and blending primary image content and temporal image content in sequences of images so as to produce motion picture sequences.
